(19) United States
(12) Patent Application Publication
(10) Pub. No.: US 2025/0330266 A1
(43) Pub. Date: Oct. 23, 2025

(54) TECHNIQUES FOR STAIRCASE ENCODING WITH BLOCK-CODE-BASED SHAPING

(71) Applicant: QUALCOMM Incorporated, San Diego, CA (US)

(72) Inventors: Liangming WU, Beijing (CN); Wei LIU, Beijing (CN); Changlong XU, Beijing (CN); Jian LI, Shanghai (CN); Kexin XIAO, Shanghai (CN); Thomas Joseph RICHARDSON, South Orange, NJ (US)

(21) Appl. No.: 18/870,144

(22) PCT Filed: Jul. 30, 2022
(86) PCT No.: PCT/CN2022/109278

§ 371 Date: Nov. 27, 2024

(51) Int. Cl. H04L 1/00

(52) U.S. Cl. CPC H04L 1/0042; H04L 1/0047

(57) ABSTRACT

Methods, systems, and devices for wireless communications are described. A first device may identify parameters for staircase encoding. The first device may perform a staircase encoding procedure on information bits in accordance with the parameters to generate encoded bits. At current step of the staircase encoding procedure, the first device may concatenate a first set of shaping bits with a first set of information bits to generate a second set of bits, perform a channel decoding procedure on the second set of bits to generate a second set of shaping bits for a subsequent step of the staircase encoding procedure, perform an encoding procedure on a third set of bits to generate a set of parity bits, and map the third set of bits and the set of parity bits to a set of symbols to generate a fourth set of bits for the subsequent step.

### CROSS REFERENCE

The present Application is a 371 national stage filing of International PCT Application No. PCT/CN2022/109278 by WU et al. entitled “TECHNIQUES FOR STAIRCASE ENCODING WITH BLOCK-CODE-BASED SHAPING,” filed Jul. 30, 2022, which is assigned to the assignee hereof, and which is expressly incorporated by reference in its entirety herein.

### FIELD OF TECHNOLOGY

The following relates to wireless communications, including techniques for staircase encoding with block-code-based shaping.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for staircase encoding with block-code-based shaping. For example, the described techniques provide a framework for configuring a wireless device to perform staircase encoding with block-code-based shaping. In some examples, a first wireless device may communicate control signaling identifying one or more parameters for staircase encoding. The first wireless device may perform a staircase encoding procedure on a set of multiple information bits in accordance with the one or more parameters to generate a set of encoded bits. In some examples, as part of a current step of the staircase encoding procedure, the first wireless device may concatenate a first set of shaping bits with a first set of information bits to generate a second set of bits. The first set of shaping bits may be associated with shaping a first set of bits from a previous step of the staircase encoding procedure and the first set of information bits may be associated with the current step. The first wireless device may perform a channel decoding procedure on the second set of bits to generate a second set of shaping bits to be used in a subsequent step of the staircase encoding procedure. The first wireless device may perform a forward error correction (FEC) encoding procedure on a third set of bits to generate a set of parity bits. The third set of bits may be based on the second set of bits. The first wireless device may map the third set of bits and the set of parity bits to a set of symbols to generate a fourth set of bits for the subsequent step of the staircase encoding procedure. The first wireless device may transmit the set of encoded bits to a second wireless device.

A method for wireless communication at a first wireless device is described. The method may include communicating control signaling identifying one or more parameters for staircase encoding, performing, in accordance with the one or more parameters, a staircase encoding procedure on a set of multiple information bits to generate a set of encoded bits, the staircase encoding procedure at a current step including, concatenating a first set of shaping bits with a first set of information bits to generate a second set of bits, the first set of shaping bits associated with shaping a first set of bits from a previous step of the staircase encoding procedure, and the first set of information bits for the current step, performing a channel decoding procedure on the second set of bits to generate a second set of shaping bits to be used in a subsequent step of the staircase encoding procedure, performing a FEC encoding procedure on a third set of bits to generate a set of parity bits, the third set of bits being based on the second set of bits, mapping the third set of bits and the set of parity bits to a set of symbols to generate a fourth set of bits for the subsequent step of the staircase encoding procedure, and transmitting the set of encoded bits to a second wireless device.

An apparatus for wireless communication at a first wireless device is described. The apparatus may include a processor, memory coupled with the processor, and instructions stored in the memory. The instructions may be executable by the processor to cause the apparatus to communicate control signaling identifying one or more parameters for staircase encoding, perform, in accordance with the one or more parameters, a staircase encoding procedure on a set of multiple information bits to generate a set of encoded bits, the staircase encoding procedure at a current step including, concatenate a first set of shaping bits with a first set of information bits to generate a second set of bits, the first set of shaping bits associated with shaping a first set of bits from a previous step of the staircase encoding procedure, and the first set of information bits for the current step, perform a channel decoding procedure on the second set of bits to generate a second set of shaping bits to be used in a subsequent step of the staircase encoding procedure, perform a FEC encoding procedure on a third set of bits to generate a set of parity bits, the third set of bits being based on the second set of bits, map the third set of bits and the set of parity bits to a set of symbols to generate a fourth set of bits for the subsequent step of the staircase encoding procedure, and transmit the set of encoded bits to a second wireless device.

Another apparatus for wireless communication at a first wireless device is described. The apparatus may include means for communicating control signaling identifying one or more parameters for staircase encoding, means for performing, in accordance with the one or more parameters, a staircase encoding procedure on a set of multiple information bits to generate a set of encoded bits, the staircase encoding procedure at a current step including, means for concatenating a first set of shaping bits with a first set of information bits to generate a second set of bits, the first set of shaping bits associated with shaping a first set of bits from a previous step of the staircase encoding procedure, and the first set of information bits for the current step, means for performing a channel decoding procedure on the second set of bits to generate a second set of shaping bits to be used in a subsequent step of the staircase encoding procedure, means for performing a FEC encoding procedure on a third set of bits to generate a set of parity bits, the third set of bits being based on the second set of bits, means for mapping the third set of bits and the set of parity bits to a set of symbols to generate a fourth set of bits for the subsequent step of the staircase encoding procedure, and means for transmitting the set of encoded bits to a second wireless device.

A non-transitory computer-readable medium storing code for wireless communication at a first wireless device is described. The code may include instructions executable by a processor to communicate control signaling identifying one or more parameters for staircase encoding, perform, in accordance with the one or more parameters, a staircase encoding procedure on a set of multiple information bits to generate a set of encoded bits, the staircase encoding procedure at a current step including, concatenate a first set of shaping bits with a first set of information bits to generate a second set of bits, the first set of shaping bits associated with shaping a first set of bits from a previous step of the staircase encoding procedure, and the first set of information bits for the current step, perform a channel decoding procedure on the second set of bits to generate a second set of shaping bits to be used in a subsequent step of the staircase encoding procedure, perform a FEC encoding procedure on a third set of bits to generate a set of parity bits, the third set of bits being based on the second set of bits, map the third set of bits and the set of parity bits to a set of symbols to generate a fourth set of bits for the subsequent step of the staircase encoding procedure, and transmit the set of encoded bits to a second wireless device.

In some examples of the method, apparatuses, and non-transitory computer-readable medium described herein, communicating the control signaling identifying the one or more parameters for staircase encoding may include operations, features, means, or instructions for communicating an indication of a length of each code block of a set of multiple code blocks to be used for staircase encoding, where the second set of bits may be based on the length.

Some examples of the method, apparatuses, and non-transitory computer-readable medium described herein may further include operations, features, means, or instructions for determining, based on the length of each code block, a quantity of component codes to be used for channel decoding, where performing the channel decoding procedure may be based on the quantity of component codes.

In some examples of the method, apparatuses, and non-transitory computer-readable medium described herein, communicating the control signaling identifying the one or more parameters for staircase encoding may include operations, features, means, or instructions for communicating an indication of a coding rate to be used for staircase encoding, where the second set of shaping bits may be based on the coding rate.

In some examples of the method, apparatuses, and non-transitory computer-readable medium described herein, the second set of shaping bits may be further based as least in part on a quantity of bits to be carried by each symbol of the set of symbols.

In some examples of the method, apparatuses, and non-transitory computer-readable medium described herein, communicating the control signaling identifying the one or more parameters for staircase encoding may include operations, features, means, or instructions for communicating an indication of a quantity of component codes to be used for channel decoding, where the channel decoding procedure may be performed using one or more component codes based on the quantity of component codes.

In some examples of the method, apparatuses, and non-transitory computer-readable medium described herein, the channel decoding procedure and the FEC encoding procedure may be performed concurrently at least in part.

In some examples of the method, apparatuses, and non-transitory computer-readable medium described herein, the FEC encoding procedure may be performed subsequently to the channel decoding procedure.

In some examples of the method, apparatuses, and non-transitory computer-readable medium described herein, performing the staircase encoding procedure may include operations, features, means, or instructions for performing a channel encoding procedure using the second set of bits to generate the third set of bits, where performing the FEC encoding procedure may be based on the channel encoding procedure.

In some examples of the method, apparatuses, and non-transitory computer-readable medium described herein, the third set of bits includes cover code bits.

Some examples of the method, apparatuses, and non-transitory computer-readable medium described herein may further include operations, features, means, or instructions for performing a bit-masking procedure on a portion of the third set of bits, to obtain a shaped portion of the third set of bits, where the FEC encoding procedure may be further based on the bit-masking procedure.

In some examples of the method, apparatuses, and non-transitory computer-readable medium described herein, the first wireless device includes a user equipment (UE), and communicating the control signaling identifying the one or more parameters for staircase encoding may include operations, features, means, or instructions for receiving the control signaling identifying the one or more parameters for staircase encoding, where performing the staircase encoding procedure may be based on receiving the control signaling.

In some examples of the method, apparatuses, and non-transitory computer-readable medium described herein, the first wireless device includes a network entity, and communicating the control signaling identifying the one or more parameters for staircase encoding may include operations, features, means, or instructions for transmitting the control signaling identifying the one or more parameters for staircase encoding, where performing the staircase encoding procedure may be based on transmitting the control signaling.

In some examples of the method, apparatuses, and non-transitory computer-readable medium described herein, the channel decoding procedure may be performed using a polar decoder.

A method for wireless communication at a second wireless device is described. The method may include communicating control signaling identifying one or more parameters for staircase decoding, receiving a set of symbols from a first wireless device, performing, in accordance with the one or more parameters, a staircase decoding procedure on the set of symbols to generate a set of information bits, the staircase decoding procedure at a current step including, mapping the set of symbols to a first set of bits for the current step of the staircase decoding procedure, performing a FEC decoding procedure on the first set of bits to generate a set of shaping bits and a second set of bits to be used in the current step of the staircase decoding procedure, performing a bit-masking procedure on the second set of bits to generate a third set bits to be used in a subsequent step of the staircase decoding procedure, the bit-masking procedure based on the set of shaping bits, and outputting the set of information bits.

An apparatus for wireless communication at a second wireless device is described. The apparatus may include a processor, memory coupled with the processor, and instructions stored in the memory. The instructions may be executable by the processor to cause the apparatus to communicate control signaling identifying one or more parameters for staircase decoding, receive a set of symbols from a first wireless device, perform, in accordance with the one or more parameters, a staircase decoding procedure on the set of symbols to generate a set of information bits, the staircase decoding procedure at a current step including, map the set of symbols to a first set of bits for the current step of the staircase decoding procedure, perform a FEC decoding procedure on the first set of bits to generate a set of shaping bits and a second set of bits to be used in the current step of the staircase decoding procedure, perform a bit-masking procedure on the second set of bits to generate a third set bits to be used in a subsequent step of the staircase decoding procedure, the bit-masking procedure based on the set of shaping bits, and output the set of information bits.

Another apparatus for wireless communication at a second wireless device is described. The apparatus may include means for communicating control signaling identifying one or more parameters for staircase decoding, means for receiving a set of symbols from a first wireless device, means for performing, in accordance with the one or more parameters, a staircase decoding procedure on the set of symbols to generate a set of information bits, the staircase decoding procedure at a current step including, means for mapping the set of symbols to a first set of bits for the current step of the staircase decoding procedure, means for performing a FEC decoding procedure on the first set of bits to generate a set of shaping bits and a second set of bits to be used in the current step of the staircase decoding procedure, means for performing a bit-masking procedure on the second set of bits to generate a third set bits to be used in a subsequent step of the staircase decoding procedure, the bit-masking procedure based on the set of shaping bits, and means for outputting the set of information bits.

A non-transitory computer-readable medium storing code for wireless communication at a second wireless device is described. The code may include instructions executable by a processor to communicate control signaling identifying one or more parameters for staircase decoding, receive a set of symbols from a first wireless device, perform, in accordance with the one or more parameters, a staircase decoding procedure on the set of symbols to generate a set of information bits, the staircase decoding procedure at a current step including, map the set of symbols to a first set of bits for the current step of the staircase decoding procedure, perform a FEC decoding procedure on the first set of bits to generate a set of shaping bits and a second set of bits to be used in the current step of the staircase decoding procedure, perform a bit-masking procedure on the second set of bits to generate a third set bits to be used in a subsequent step of the staircase decoding procedure, the bit-masking procedure based on the set of shaping bits, and output the set of information bits.

In some examples of the method, apparatuses, and non-transitory computer-readable medium described herein, communicating the control signaling identifying the one or more parameters for staircase encoding may include operations, features, means, or instructions for communicating an indication of a length of each code block of a set of multiple code blocks to be used for staircase decoding, where the second set of bits may be based on the length.

In some examples of the method, apparatuses, and non-transitory computer-readable medium described herein, communicating the control signaling identifying the one or more parameters for staircase decoding may include operations, features, means, or instructions for communicating an indication of a coding rate to be used for staircase decoding, where the set of shaping bits may be based on the coding rate.

In some examples of the method, apparatuses, and non-transitory computer-readable medium described herein, the set of shaping bits may be further based as least in part on a quantity of bits carried by each symbol of the set of symbols.

In some examples of the method, apparatuses, and non-transitory computer-readable medium described herein, communicating the control signaling identifying the one or more parameters for staircase decoding may include operations, features, means, or instructions for communicating an indication of a quantity of component codes to be used for staircase decoding, where the staircase decoding procedure may be based on the quantity of component codes.

In some examples of the method, apparatuses, and non-transitory computer-readable medium described herein, performing the staircase decoding procedure may include operations, features, means, or instructions for performing a channel encoding procedure on the set of shaping bits, where the bit-masking procedure may be based on performing the channel encoding procedure.

In some examples of the method, apparatuses, and non-transitory computer-readable medium described herein, the second wireless device includes a UE, and communicating the control signaling identifying the one or more parameters for staircase encoding may include operations, features, means, or instructions for receiving the control signaling identifying the one or more parameters for staircase decoding, where performing the staircase decoding procedure may be based on receiving the control signaling.

In some examples of the method, apparatuses, and non-transitory computer-readable medium described herein, the second wireless device includes a network entity, and communicating the control signaling identifying the one or more parameters for staircase decoding may include operations, features, means, or instructions for transmitting the control signaling identifying the one or more parameters for staircase decoding, where performing the staircase decoding procedure may be based on transmitting the control signaling.

### BRIEF DESCRIPTION OF THE DRAWINGS

FIGS. 1 and 2 each illustrate an example of a wireless communications system that supports techniques for staircase encoding with block-code-based shaping in accordance with one or more aspects of the present disclosure.

FIG. 3 illustrates an example of a staircase encoding scheme that supports techniques for staircase encoding with block-code-based shaping in accordance with one or more aspects of the present disclosure.

FIG. 4 illustrates an example of a staircase decoding scheme that supports techniques for staircase encoding with block-code-based shaping in accordance with one or more aspects of the present disclosure.

FIGS. 5 and 6 each illustrates an example of a process flow that supports techniques for staircase encoding with block-code-based shaping in accordance with one or more aspects of the present disclosure.

FIGS. 7 and 8 show block diagrams of devices that support techniques for staircase encoding with block-code-based shaping in accordance with one or more aspects of the present disclosure.

FIG. 9 shows a block diagram of a communications manager that supports techniques for staircase encoding with block-code-based shaping in accordance with one or more aspects of the present disclosure.

FIG. 10 shows a diagram of a system including a device that supports techniques for staircase encoding with block-code-based shaping in accordance with one or more aspects of the present disclosure.

FIGS. 11 and 12 show block diagrams of devices that support techniques for staircase encoding with block-code-based shaping in accordance with one or more aspects of the present disclosure.

FIG. 13 shows a block diagram of a communications manager that supports techniques for staircase encoding with block-code-based shaping in accordance with one or more aspects of the present disclosure.

FIG. 14 shows a diagram of a system including a device that supports techniques for staircase encoding with block-code-based shaping in accordance with one or more aspects of the present disclosure.

FIGS. 15 and 16 show flowcharts illustrating methods that support techniques for staircase encoding with block-code-based shaping in accordance with one or more aspects of the present disclosure.

### DETAILED DESCRIPTION

In some wireless communications systems, a first communication device (e.g., a user equipment (UE), a network entity) may use higher-order modulation schemes (e.g., 16 quadrature amplitude modulation (QAM), 64 QAM, 256 QAM) to improve the reliability with which a second communication device (e.g., another UE, another network entity) may recover source information of a modulated signal (e.g., modulated using the higher-order modulation scheme). For example, as part of higher-order modulation schemes, the first communication device (e.g., a transmitting device) may map a bit sequence to a symbol sequence and transmit the symbol sequence to the second communication device (e.g., a receiving device) using a communication channel (e.g., via the modulated signal transmitted using a wireless medium). An information rate (e.g., a quantity of bits that may be transmitted per symbol of the symbol sequence) achievable using some higher-order modulation schemes may be reduced relative to a capacity of the communication channel (e.g., an achievable rate at which information may be reliably transmitted using the communication channel). A difference between the information rate achievable using such higher-order modulation schemes and the capacity of the communication channel (e.g., the channel capacity) may be referred to as a shaping gap.

In some examples, to reduce the shaping gap (e.g., to achieve an information rate that approaches channel capacity), the communication device may use probabilistic amplitude shaping, in which bit sequences (e.g., sequences of information bits) may be mapped to symbol sequences with relatively low energy (e.g., relative to other possible symbol sequences that may be used for mapping). In some examples, however, some techniques for probabilistic amplitude shaping may be complex and lead to increased computation costs at the first communication device and the second communication device. In some instances, to reduce complexity at the second communication device (e.g., the receiving device), the first communication device (e.g., the transmitting device) may use block-code-based shaping in which shaped information bits (e.g., data to be transmitted) may be jointly encoded with shaping bits (e.g., bits that may indicate how the information bits are shaped). In some examples, however, the necessity of transmitting the shaping bits with the shaped information bits may lead to increased complexity and reduced performance at the first communication device.

Various aspects of the present disclosure generally relate to techniques for staircase encoding with block-code-based shaping, and more specifically, to a framework for combining block-code-based shaping with staircase encoding. In some examples, staircase encoding (e.g., row and column encoding) may provide for unterminated codes (e.g., codes which may have an indeterminate block length) that support increased throughput. As such, the first communication device may leverage the structure of staircase encoding to transmit shaping bits (e.g., generated as part of the block-based shaping), thereby improving performance while reducing complexity at the first communication device and the second communication device. In some examples, to enable staircase encoding with block-code-based shaping, the network may configure the first communication device with one or more parameters. For example, the network may transmit control signaling that indicates, to the first communication device, a length of a code block (e.g., a staircase code block), a coding rate, and a quantity of component codes to be shaped (e.g., using block-code-based shaping).

Particular aspects of the subject matter described herein may be implemented to realize one or more of the following potential advantages. The techniques employed by the described communication devices may provide benefits and enhancements to operations of the communication devices, including encoding and decoding information bits for wireless communications. For example, operations performed by the described communication devices may provide one or more enhancements for staircase encoding (or decoding) operations by combining the staircase encoding (or decoding) with block-code-based. In some implementations, the operations performed by the described communication devices to combine block-code-based shaping with staircase encoding (or staircase decoding) may include configuring the communication device with a length of a code block (e.g., a staircase code block), a coding rate, and a quantity of component codes to be shaped (e.g., using block-code-based shaping). In some other implementations, operations performed by the described communication devices may also support reduced processing, increased throughput, and higher data rates, among other benefits.

Aspects of the disclosure are initially described in the context of wireless communications systems. Aspects of the disclosure are also described in the context of a staircase encoding scheme, a staircase decoding scheme, and process flows. Aspects of the disclosure are further illustrated by and described with reference to apparatus diagrams, system diagrams, and flowcharts that relate to techniques for staircase encoding with block-code-based shaping.

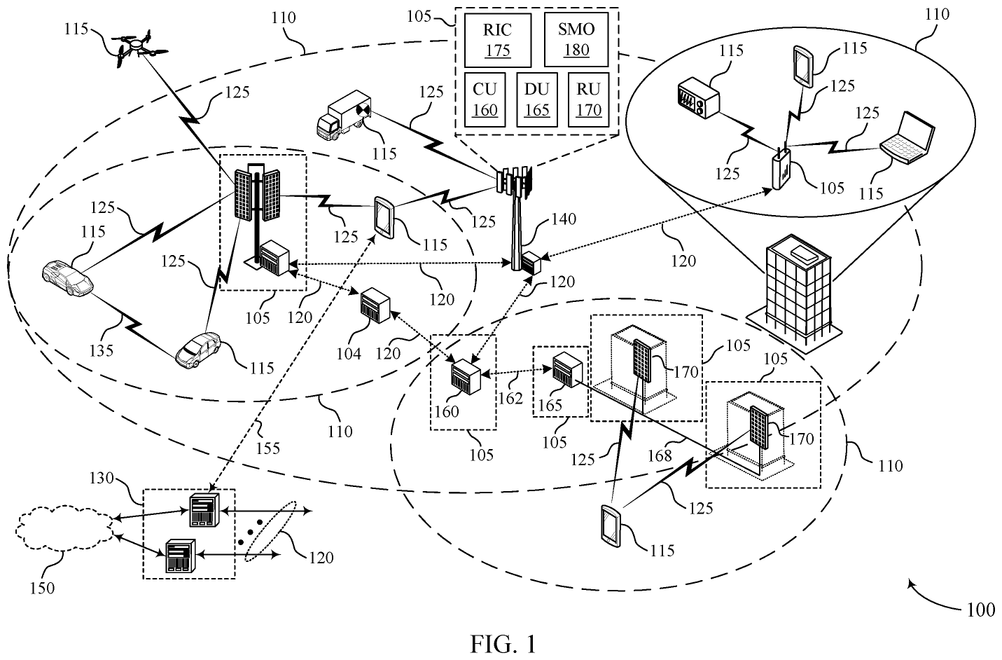

FIG. 1 illustrates an example of a wireless communications system 100 that supports techniques for staircase encoding with block-code-based shaping in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for staircase encoding with block-code-based shaping as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of T_{S}=1/(AΔfₘₐₓ−N_{f}) seconds, for which Δfₙₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may support a framework for configuring a wireless device to perform staircase encoding with block-code-based shaping. For example, a first wireless device (e.g., a UE 115, a network entity 105) may communicate control signaling identifying one or more parameters for staircase encoding. The first wireless device may perform a staircase encoding procedure on a set of multiple information bits in accordance with the one or more parameters to generate a set of encoded bits. In some examples, as part of a current step of the staircase encoding procedure, the first wireless device may concatenate a first set of shaping bits with a first set of information bits to generate a second set of bits. The first set of shaping bits may be associated with shaping a first set of bits from a previous step of the staircase encoding procedure and the first set of information bits may be associated with the current step. The first wireless device may perform a channel decoding procedure on the second set of bits to generate a second set of shaping bits to be used in a subsequent step of the staircase encoding procedure. The first wireless device may perform a forward error correction (FEC) encoding procedure on a third set of bits to generate a set of parity bits. The third set of bits may be based on the second set of bits. The first wireless device may map the third set of bits and the set of parity bits to a set of symbols to generate a fourth set of bits for the subsequent step of the staircase encoding procedure. The first wireless device may transmit the set of encoded bits to a second wireless device (e.g., another UE 115, another network entity 105).

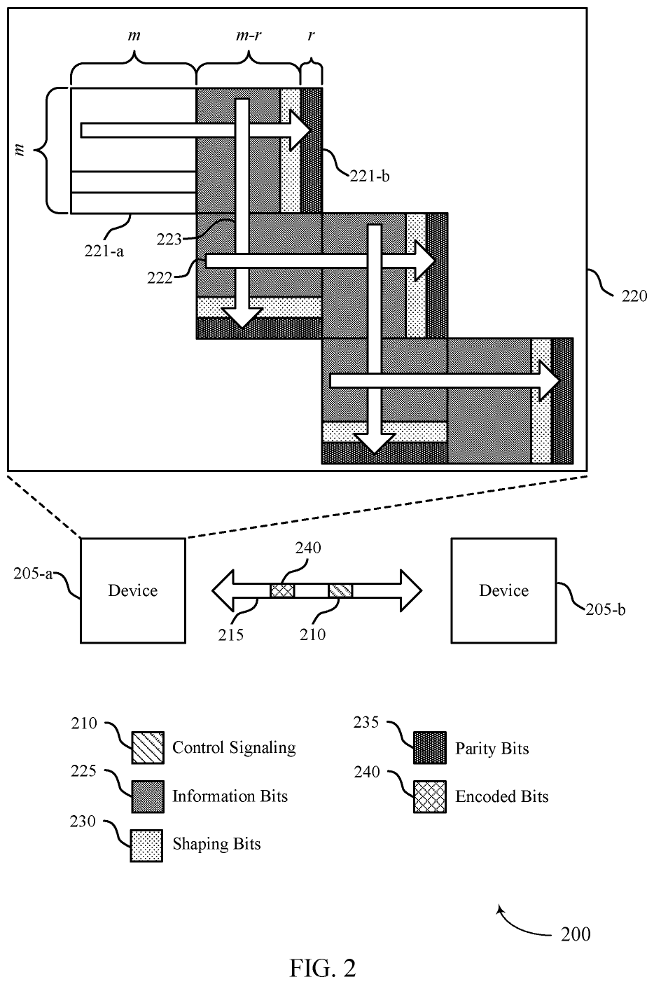

FIG. 2 illustrates an example of a wireless communications system 200 that supports techniques for staircase encoding with block-code-based shaping in accordance with one or more aspects of the present disclosure. In some examples, the wireless communications system 200 may implement aspects of the wireless communications system 100. For example, the wireless communications system 200 may include a device 205-a and a device 205-b, which may each be an example of a UE 115 or a network entity 105 as described with reference to FIG. 1. In the example of FIG. 2, the device 205-a may be a transmitting device (e.g., a device that may perform one or more encoding operations) and the device 205-b may be a receiving device (e.g., a device that may perform one or more decoding operations). The device 205-a and the device 205-b may communicate via a communication link 215, which may be an example of a communication link 125 as described with reference to FIG. 1. In the example of FIG. 2, the communication link 215 may be a downlink, an uplink, or a sidelink, among other examples.

In some examples of the wireless communications system 200, a communication device (e.g., the device 205-a, the device 205-b) may support higher-order modulation (e.g., 16 QAM, 64 QAM, 256 QAM) for wireless communications. For example, the device 205-a (e.g., a transmitting device) may implement higher-order modulation to improve a reliability with which another communication device (e.g., the device 205-b, a receiving device) may recover original source information (e.g., encoded information bits). In some examples, information (e.g., information bits) may be transmitted via a modulated signal that may be represented as symbols (e.g., phase and amplitude combinations encoded over a time duration of the modulated signal) and each symbol may be represented as a constellation point on a constellation diagram. For example, the information bits (e.g., k bits) may be represented as a quantity of constellation points (e.g., n constellation points) in which a constellation point may correspond to a symbol (e.g., a vector) of a modulated signal with a particular in-phase component (i) and a particular quadrature component (q).

In some examples, the information bits (e.g., k bits) may be mapped to the constellation symbols (e.g., n constellation points) according to an alphabet of symbols (Aₜ), in which t may correspond to a size of the alphabet (e.g., an integer greater than about 1). That is, the symbol alphabet [symbol] ₜ may include t elements (e.g., symbols). In such an example, a symbol sequence generated using the alphabet Aₜ and having length n may be referred to as an ordered n-tuple, in which elements of the sequence may correspond to values included in Aₜ. That is, a sequences generated using the alphabet Aₜ and having length n may refer to a sequence of n elements, in which each element (e.g., symbol) of the sequence may be included in the alphabet Aₜ. In some examples, an ASK constellation (e.g., a constellation of an 2^{M}-ary ASK modulation scheme) may be associated with a symbol (e.g., amplitude) alphabet of Aₜ{1,3, . . . , 2^{M}−1}, such that t=2^{M-1} and {−1,1}×Aₜ may correspond to an 2^{M}-ary ASK alphabet. That is, a length (t) of an alphabet used with a modulation scheme to generate a symbol sequence (e.g., a constellation) may depend on a modulation order of the modulation scheme. Additionally, or alternatively, an energy of a symbol aᵢ(e.g., given an alphabet Aₜ={a₁, a₂, . . . , aₜ}), may be denote as Eᵢ=E(aᵢ) for each i. In such an example, the symbol energies may be distinct for any i ∈ {1, 2, . . . , t−1}, in which 0≤E(aᵢ)<E(aᵢ₊₁). That is, the energy of a symbol may correspond to a non-negative value (e.g., a non-negative integer).

In some examples, a symbol sequence (e.g., generated using an alphabet Aₜ={a₁, a₂, . . . , aₜ} of size t) may be written as s=(s₁, s₂, . . . sₙ) in which each element of (s) may correspond to a value of the alphabet Aₜ. In such examples, an energy of the sequence (s) may be denoted as E(s) and may be defined as a summation of symbol energies (E(aᵢ)) of symbols included in the sequence. In some examples, an energy (E(aᵢ)) of a symbol corresponding to a constellation point on the constellation diagram may be proportional to the square of a distance (e.g., a Euclidean distance) between the constellation point and the origin of the constellation diagram. Additionally or alternatively the distance between constellation points may correspond to a noise tolerance. For example, an increased distance may correspond to an increased noise tolerance (e.g., of the symbol). As such, an average signal-to-noise ratio (SNR) of a constellation diagram (e.g., and an average energy) may correspond to a distribution of the constellation points within the constellation diagram.

Constellation diagrams of modulated signals in some systems, such as systems that may use higher-order modulation, may be fixed and each constellation point may be used (e.g., selected at the device 205-a) with about equal probability. For example, within the constellation diagram, each constellation point (e.g., associated with a particular phase and amplitude) may have a same (or about the same) probability of being selected (e.g., being transmitted) at the device 205-a. That is, each symbol in a symbol sequence associated with the constellation may be associated with a same fractional occurrence. In such an example, the constellation points (e.g., symbols) that have relatively high amplitudes and relatively high power may have a same probability of being selected (e.g., transmitted) as constellation points that may have relatively low amplitudes and relatively low power. That is, a distribution of the constellation points within the constellation diagram may be uniform.

Additionally, or alternatively, as a modulation order of a modulation scheme used to generate a modulated signal increases, an information rate that may be achieved using the modulation scheme (e.g., with uniform signaling) may be reduced relative to a capacity of the channel (e.g., a communication channel used for transmitting the modulated signal). For example, the capacity of a channel (e.g., a channel capacity, an upper bound of a quantity of bits that may be transmitted per symbol, an upper bound of a rate at which information may be transmitted relatively reliably using the communication channel) achievable using a modulation scheme (e.g., 16 QAM, 64 QAM, or 256 QAM) may be associated with an SNR of the modulated signal (e.g., obtained using the modulation scheme). As such, a modulation and coding scheme may have a particular SNR to achieve a particular information rate. In some examples, a difference between an SNR (e.g., of a modulated signal) at which a particular information rate may be achieved and another SNR at which channel capacity may be achieved (e.g., an SNR associated with an information rate of a maximum capacity-achieving scheme or otherwise suitable capacity-achieving scheme) may be referred to as a shaping gap. That is, the shaping gap may refer to a difference between a rate of information (e.g., the information rate) achievable using a modulation and coding scheme and the channel capacity (e.g., an unconstrained channel capacity) of an additive white Gaussian noise (AWGN) channel at a particular SNR.

In some examples, constellation shaping may be applied to reduce the shaping gap. For example, if the distribution (e.g., the input distribution of the constellation points within the constellation diagram) is a Gaussian distribution, an increased channel capacity of the modulation scheme (e.g., over an AWGN channel) may be achieved. In some examples, a noise of a modulated signal may be reduced by reducing an average energy of the corresponding constellation. That is, an average SNR of the constellation diagram may be increased (e.g., and an average energy reduced) by varying the relative distance between constellation points or by varying a probability with which particular constellation points may be selected (e.g., by varying the fractional occurrence of some constellation points relative to other constellation points). For example, the average energy of the constellation diagram may be reduced by increasing the fractional occurrence of constellation points that may be a relatively small distance from the origin (e.g., constellation points that may have a relatively low energy) and reducing the fractional occurrence of constellation points that may be a relatively large distance from the origin (e.g., constellation points that may have a relatively high energy).

In some examples, some techniques to reduce (e.g., close) the shaping gap (e.g., and reduce the SNR) may include probabilistic shaping. For example, probabilistic shaping may enable symbols to be transmitted with a QAM shape and non-uniform probability. That is, probabilistic shaping may enable a non-uniformly distributed constellation (e.g., a constellation with a Maxwell-Boltzmann distribution) that may approach channel capacity. For example, probabilistic shaping may employ equidistant constellation points and may implement one or more non-uniform (e.g., Gaussian-like) signal distributions. That is, for probabilistic shaping, a relative distance between different constellation points (e.g., within the constellation diagram) may be about equal and a probability of selecting a particular constellation point (e.g., to be transmitted) may be non-uniform (e.g., Gaussian-like). For example, constellation points with relatively low amplitudes (e.g., relatively low power, relatively low energy) may have an increased probability of being selected compared to constellation points with relatively high amplitudes (e.g., relatively high power, relatively high energy), such as to achieve a Gaussian-like signal distribution.

In some examples, the probability distribution of constellation points for probabilistic shaping may be modified to achieve a discrete Gaussian-like distribution, such as the Maxwell-Boltzmann distribution. For example, the Maxwell-Boltzmann distribution of constellation points (e.g., amplitudes within a constellation diagram, such as an amplitude shift keying (ASK) constellation diagram) may provide a symmetric probability distribution, pᵥ(x), of a form described according to the following Equation 1:

$${p}_{v} ( x ) = \frac{1}{{z}_{v}} {e}^{- {vx}^{2}} , x ∈ \{ \pm 1 , \pm 3 , … , \pm ( {2}^{M} - 1 ) \} \qquad ( 1 )$$

in which v may correspond to a non-negative integer (e.g., an integer greater than or equal to about 0). For example, a 2^{M}-ary ASK constellation may include a set of symbols (e.g., {±1, +3, . . . ,±(2^{M}−1)}) with an amplitude alphabet (e.g., [symbol] ={1,3, . . . , 2^{M}−1}). In some examples, a Maxwell-Boltzmann-distributed input [symbol] may exhibit a shaping gain (e.g., an increase in the information rate for a same power or an increase in energy efficiency for a same information rate achieved by probabilistic shaping relative to signaling using an AWGN channel) relative to a uniformly distributed input (e.g., within an ASK constellation, relative to a constellation for an ASK modulation scheme).

In some examples, probabilistic amplitude shaping (PAS) may be used (e.g., at the device 205-a, or the device 205-b, or both) as a technique to perform probabilistic shaping. In some examples, PAS may provide relatively large (or otherwise suitable) shaping gain. For example, PAS may enable bit sequences (e.g., input of the PAS) to be mapped to symbol sequences based on an energy of the symbol sequences (e.g., according to an ordering of the symbol sequences that may be based on a respective energy of each sequence). That is, PAS may enable bit sequences to be mapped to a quantity of symbol sequences (e.g., 2^{k} symbol sequences of length (n) with a relatively low energy (e.g., a minimal or otherwise suitable energy) and, as such, may lead to a distribution that may approach a Maxwell-Boltzmann distribution (e.g., a discrete Gaussian-like distribution).

In some examples, PAS may occur (e.g., be realized at) at a distribution matcher. For example, the device 205-a (e.g., a transmitting device) may use the distribution matcher (e.g., a non-linear precoder) to transforms uniformly distributed bit sequences into symbol sequences with a non-uniform (e.g., irregular) distribution. That is, the device 205-a may use the distribution matcher to generate a symbol sequence of n amplitudes from a bit sequence of k bits. In some examples, the shaped output (e.g., the symbol sequence of n amplitudes) may correspond to one-dimension ASK sequence length. For example, the distribution matcher may map a length-k bit sequence to a length-n amplitude sequence and induce a non-uniform (e.g., marginal) distribution of the amplitude symbols. In some examples, the k bits may be independent and distributed (e.g., identically distributed) with a uniform distribution. Additionally, or alternatively, the non-uniform distribution over the amplitude symbols (e.g., using the amplitude symbols) may be closer to the capacity-achieving distribution relative to the uniform distribution. That is, the non-uniform distribution may be a Gaussian-like distribution (e.g., may approximate a Gaussian distribution) or may be a Maxwell-Boltzmann distribution (e.g., in the AWGN context). In some examples, the distribution matcher may have a distribution matching rate determined in accordance with the following Equation 2:

$${R}_{s} = k / n \qquad ( 2 )$$

in which k may correspond to a quantity of bits (e.g., information bits) input into the distribution matcher and n may correspond to a quantity of symbol amplitudes (e.g., symbols) output from the distribution matcher. The device 205-a may use an amplitude-to-bit mapper to generate a first quantity of bits (e.g., n(m−1) amplitude bits) from the n amplitudes. In some examples, the parameter m may correspond to a quantity of bits per one-dimension (e.g., log based 2 of the 2^{M}-ASK size). Additionally, or alternatively, the first quantity of bits (e.g., the n(m−1) amplitude bits) and a second quantity of bits (e.g., γn bits, in which γ may be an integer and correspond to a rate of data bits carried over the symbol signs) may be input into a systematic forward-error-correction (FEC) encoder to generate a third quantity of bits (e.g., n(m−1) shaped bits), a quantity of shaped bits (e.g., γn non-shaped bits), and a quantity of parity bits (e.g., n(1−γ) parity bits). In some examples, the systematic FEC encoder may have a systematic FEC code rate determined in accordance with Equation 3:

$${R}_{c} = ( m - 1 + γ ) / m \geq ( m - 1 ) / m \qquad ( 3 )$$

In some examples, the device 205-a may use the parity bits and the shaped bits to generate a quantity of sign bits (e.g., n sign bits). In some examples, as part of generating the sign bits, the device 205-a may map bits with a value of 0 to bits with a value of 1 and bits with a value 1 to bits with a value of −1. That is, the device 205-a may perform a bit flipping operation. Additionally, or alternatively, the device 205-a may use a modulator (e.g., may multiply, such as point-wise, the n sign bits with the n amplitudes) to generate the constellation points (e.g., a modulated signal including n constellation points). In some examples, the device 205-a may transmit the modulated signal (e.g., the n constellation points) to the device 205-b. For example, the device 205-a may transmit the constellation points with a transmission rate (Rₜ) that may be determined in accordance with Equation 4:

$${R}_{t} = {R}_{s} + γ < H ( A ) + γ \qquad ( 4 )$$

in which H(A) may correspond to an entropy of a constellation point (a) and may be represented in accordance with the following Equation 5:

$$H ( A ) = {\sum }_{a ∈ A} - p ( a ) {log}_{2} ( p ( a ) ) . \qquad ( 5 )$$

In some examples, while PAS may lead to increased capacity (e.g., relative to other types of coding-modulation schemes), PAS may also lead to increased processing latency (e.g., a bottleneck in processing due to serial processing of arithmetic coding) at both the device 205-a (e.g., the transmitter) and the device 205-b (e.g., the receiver).

In some other examples, the device 205-a may use a shaping encoder to shape (e.g., mask) the information bits and encode (e.g., jointly encode) the shaped information bits and the information for shaping (e.g., bits indicating how the information bits may have been shaped, shaping bits). In such examples, the device 205-b (e.g., the decoding device) may decode (e.g., jointly decode) the shaped information bits (e.g., and the information for shaping) and reencode the bits to obtain the source information (e.g., the original information bits encoded at the device 205-a). In some examples, block-code-based shaping may provide reduced complexity at the device 205-b (e.g., at the receiver), for example due to leverage one or more encoder and decoders (e.g., at the device 205-b). Additionally, or alternatively, block-code-based shaping (e.g., using polar code) may be unassociated with arithmetic coding and may lead to reduced processing.

In some examples, polar code (e.g., implemented using a polar code configuration that may include polarization weight sequence, successive cancellation decoding, and a rate of about ½) may provide one or more enhancements to higher order modulation schemes (e.g., schemes with a modulation order of 256 QAM) relative to arithmetic code (e.g., in which a symbol sequence length may be between about 64 and 4096 symbols and a symbol distribution for constant composition distribution matching (CCDM) may be about 0.4321, 0.3568696, 0.2333333, and 0.155555). In such examples, a complexity associated with the polar code may be insensitive to the rate (e.g., the rate of about ½). Additionally, or alternatively, the polar code may reduce a running time (e.g., at a transmitter and a receiver, such as with a CPU at 1.70 to 1.90 GHz averaged through 1000 rounds) associated with arithmetic code by about half. In such examples, a running time associated with the polar code at the receiver may be negligible. Additionally, or alternatively, the polar code may provide reduced complexity and latency (e.g., addition and subtraction may be utilized with reduced memory cost). In some examples, the polar code may enable acceleration (e.g., fast successive cancellation) with some parallel processing. Moreover, arithmetic code may lead to a reduced processing (e.g., a bottleneck in processing), for example due to bit-by-bit processing and dividend operations. That is, while some constellation shaping methods may target particular distributions, such as via arithmetic coding (e.g., CCDM) which may lead to increased complexity (e.g., which may become a bottleneck for some increased throughput scenarios), block-code-based shaping may use the shaping bits to shape the information, which may lead to reduced transmit power (e.g., and the shaping bits being transmitted as overhead). In some examples, however, the necessity of transmitting the information for shaping (e.g., determining how to transmit the shaping bits) with the shaped information bits may lead to increased complexity and degraded performance at the device 205-a. That is, a complexity associated with block-code-based shaping may be reduced relative to some arithmetic coding approaches (e.g., multiplication and dividends may not be utilized).

In some examples, the device 205-a may implement staircase code 220 (e.g., row and column encoding), which may provide for unterminated codes (e.g., codes which may have an indeterminate block length) and support increased throughput. For example, staircase encoding (e.g., a staircase code, a step of the staircase code) may include (e.g., result from) one or more iterations of a row encode 222 and a column encode 223. In some examples, a code block (e.g., a code block 221-a and a code block 221-b), which may also be referred to as a sub-block of the staircase code, may be represented as an m×m matrix (e.g., Bᵢ=m×m). In such an example, the staircase code 220 may be initialized to an all-zeros state. That is, a relatively first code block (e.g., the code block 221-a) may correspond to an m×m array of zero symbols. Additionally, or alternatively, a subsequent code block (e.g., a code block 221-b) may include a quantity of information bits 225 (e.g., m(m−r) information bits associated with the code block 221-b), a quantity of shaping bits 230 (e.g., from a previous code block), and a quantity of parity bits 235 (e.g., mr parity bits, that may result from encoding the information bits 225 and the shaping bits 230). In some examples, staircase encoding (e.g., of the staircase code 220) may proceed recursively on the code blocks 221 (Bᵢ). That is, each subsequent code block 221 (e.g., Bᵢ₊₁) may depend on the preceding code block 221 (e.g., B). For example, for each i-th code block (e.g., the code block 221-a, the code block 221-b) the information bits 225 (e.g., m(m−r) information bits, such as from a streaming source) may be arranged into one or more columns (e.g., a m−r columns) and the parity bits 235 (e.g., mr parity bits) may be arranges into one or more other columns (e.g., r columns).

In some examples, the entries of a previous code block Bᵢ₋₁ may be computed such that a row (e.g., each row) of the matrix may correspond to a codeword (e.g., a valid codeword). Additionally, or alternatively, in some examples, a step of the staircase code (e.g., a row encode and a column encode) may be performed using an FEC encoder and with a code length of 2m. For example, a step of the staircase code may include m codewords. Additionally, or alternatively, a staircase code rate may be determined in accordance with the following Equation 6:

$$\frac{m - r}{m} \qquad ( 6 )$$

in which r may correspond to a length of the parity bits. Additionally, or alternatively, a component FEC encoding rate may be determined in accordance with the following Equation 7:

$$\frac{2 m - r}{2 m} . \qquad ( 7 )$$

In some examples, the staircase code 220 may correspond to a spatial coupled codes, which may have an increased (e.g., infinite or otherwise suitable) transmission structure and provide improved performance for scenarios in which throughput may be relatively high (e.g., for streaming data or for transmitting relatively large packets). In some examples, systems that may rely on rigid (e.g., hard decision) decoding may use staircase encoding, which may employ Reed-Solomon code and Bose-Chaudhuri-Hocquenghem code as component code for the staircase encoding. Additionally, or alternatively, a decoding latency (e.g., and communication latency) associated with staircase encoding may be reduced relative to flexible (e.g., soft decision) methods (e.g., kernels), such as low-density parity-check (LDPC) codes, which may be used (e.g., suitable) for some increased throughput scenarios.

In some examples, the staircase code 220 may be employed for increased block lengths to achieve a relatively step block error rate curve. In some examples, a quantity of storage for buffering associated with staircase encoding may be relatively large. For example, for decoding with B blocks in which each block may be represented as an m² matrix, a quantity of buffered bits may be represented as B×m². As such, to avoid increased storage for buffering, a re-transmission may occur within the buffering blocks. For example, if a contiguous decoding block has a length of 4 blocks, a re-transmission may occur subsequent to the 4-th block, which may enable flexible (e.g., soft) combining of the blocks. In some examples, staircase encoding may provide reduced complexity and reduce processing latency (e.g., with hard decision decoding component code), an enhanced transmission block structure, and may enable relatively high parallel via the spatial coupled structure. In some instances, however, some shaping techniques used with staircase encoding, such as CCDM, may increase complexity that may be incompatible with relatively low complexity receivers that may be used for staircase codes.

In some examples, techniques for staircase encoding with block-code-based shaping may provide one or more enhancements to communications between the device 205-a and the device 205-b. For example, staircase code may be incorporated with polar code for shaping (e.g., block-code-based shaping). In such an example, the shaping bits of a previous staircase block (Bᵢ₋₁) may be propagated to a subsequent staircase block (e.g., a next staircase block, Bᵢ), which may provide increased flexibility and shaping gain. Additionally, or alternatively, techniques for staircase encoding with block-code-based shaping may leverage the staircase code transmission strategy to increase performance.

As illustrated in example of FIG. 2, the device 205-a may receive (or transmit) control signaling 210 identifying one or more parameters for staircase encoding. In some examples, the device 205-a may perform (e.g., in accordance with the one or more parameters), a staircase encoding procedure on a plurality of information bits to generate a set of encoded bits. In some examples, the staircase encoding procedure may include, at a current step, concatenating a first set of shaping bits 230 with a first set of information bits 225 to generate a second set of bits. In some examples, the first set of shaping bits 230 may be associated with shaping a first set of bits from a previous step of the staircase encoding procedure (e.g., associated with a code block, Bᵢ₋₁) and the first set of information bits 225 may be associated with the current step (e.g., the code block, B).

In some examples, the device 205-a may perform a channel decoding procedure (e.g., using a polar decoder) on the second set of bits to generate a second set of shaping bits 230 to be used in a subsequent step of the staircase encoding procedure (e.g., associated with a code block, Bᵢ₊₁). Additionally, or alternatively, the device 205-a may perform an FEC encoding procedure (e.g., using an FEC encoder) on a third set of bits to generate a set of parity bits 235. The device 205-a may map the third set of bits and the set of parity bits 235 to a set of symbols to generate a fourth set of bits for the subsequent step of the staircase encoding procedure (e.g., associated with a code block, Bᵢ₊₁). In some examples, the device 205-a may transmit the set of encoded bits 240 (e.g., the output of the staircase encoding procedure) to the device 205-b. In some examples, using the staircase encoding procedure with block-code-based shaping to generate the set of encoded bits 240 may improve the reliability of communications between the device 205-a and the device 205-b, among other possible benefits.

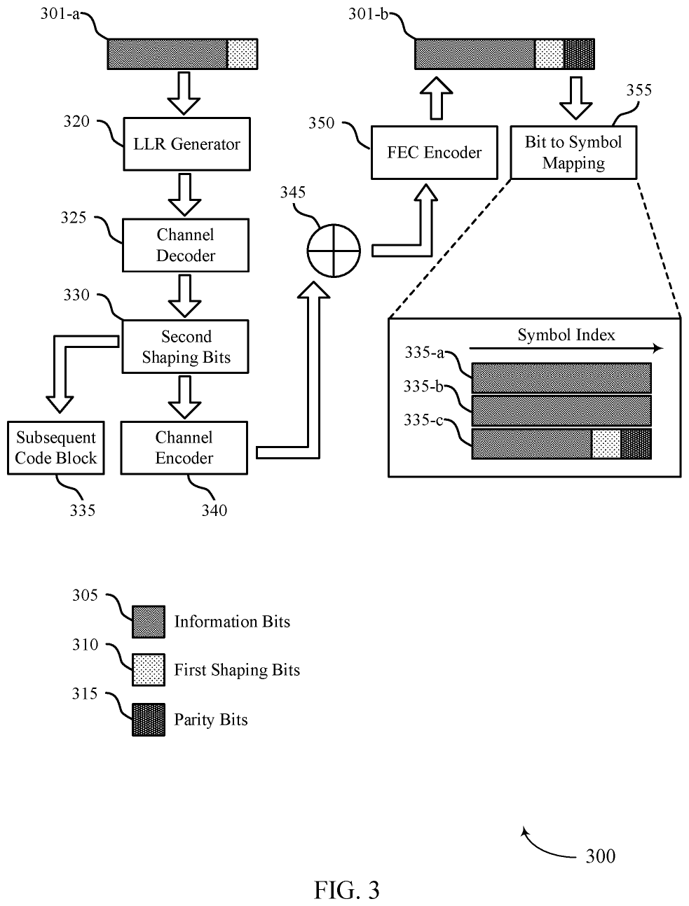

FIG. 3 illustrates an example of a staircase encoding scheme 300 that supports techniques for staircase encoding with block-code-based shaping in accordance with one or more aspects of the present disclosure. In some examples, the staircase encoding scheme 300 may implement aspects of the wireless communications system 100 and the wireless communications system 200. For example, the staircase encoding scheme 300 may be implemented at a communication device, which may be an example of a device as described with reference to FIGS. 1 and 2.

In some examples, a communication device (e.g., a wireless device) may support techniques for staircase code with block-code-based shaping. For example, a first communication device (e.g., a transmitting communication device) may support techniques for staircase encoding in which a channel decoder may be used to generate shaping bits and one or more shaping codewords that may be FEC protected. Additionally, or alternatively, a second communication device (e.g., a receiving device) may obtain (e.g., recover) encoded information bits, for example using a channel encoder with reduced complexity.

As illustrated in the example of FIG. 3, during a current iteration (e.g., a column encode or a row encode of a code block Bᵢ) of a staircase encoding procedure, the first communication device may perform one or more operations using a current code block (e.g., a component code 301-a and one or more other component codes that may be encoded in parallel). The component code 301-a may include a quantity of first shaping bits 310 of a previous code block (e.g., a component code of a previous code block (Bᵢ₋₁), such as a row encode or a column encode) and a quantity of information bits 305 associated with the current code block. That is, during the current iteration, the first communication device may concatenate the first shaping bits 310 of a previous code block with the information bits 305 of the current code block to obtain a first set of bits. In some examples of block-code-based shaping, the first communication device may utilize an LLR generator 320 to generate a cover code that may increases power savings (e.g., subsequent to bit-masking, such as at an XOR operator 345). For example, the first communication device may input the first set of bits (e.g., a set of bits that may be uniformly distributed) into the LLR generator 320 to obtain a second quantity of bits (e.g., an N×1 vector based on the input information bits). In some examples, the LLR generator 320 may generate the LLR (e.g., the N×1 vector) according to a quantity of power that may be saved by bit flipping (e.g., by flipping one or more particular bits, by performing one or more flipping operations). For example, transmitted bits may be represented as (u₀, u₁)=(1,1), and a flipping operation performed on u₀ may be represented as (u₀, u₁)=(0,1). In such an example, an associated power change (e.g., and a relative LLR) may correspond to a value of about 16.

In some examples, the first communication device may input the second set of bits into a channel decoder 325 (e.g., a polar decoder) to obtain second shaping bits 330 (e.g., a second quantity of shaping bits, K×1 shaping bits) to be used (e.g., as input) for a subsequent code block 335. That is, the second shaping bits 330 (e.g., of the current code block, of the component codes 301-a and one or more other component codes) may be concatenated and input into the subsequent code block 335 (e.g., a next code block, such as in an iterative manner).

Additionally, or alternatively, the second quantity of bits may be input into a channel encoder 340 (e.g., a polar encoder) to obtain (e.g., generate) a third quantity of bits (e.g., N cover code bits). The third set of bits may include a quantity of sign bits (e.g., sign bits 335-a), a quantity of most significant bits (MSB) (e.g., MSB 335-b), and a quantity of least significant bits (LSB) (e.g., LSB 335-c). In some examples, the device may perform a shaping operation and bit-masking operation (e.g., at the XOR operator at 345) using a portion of the third set of bits. For example, the first communication device may perform the shaping operation using the MSB 335-b (e.g., length NMSB, a shaping codeword obtained from the channel encoder 340). In such an example, overhead to the system may include the first shaping bits 310, which may be protected (e.g., jointly protected) with the shaped information bits (e.g., the MSB 335-b, a shaped information bit sequence) using an FEC encoder 350. That is, the first communication device may use the FEC encoder 350 to encode (e.g., jointly encode) the first shaping bits 310 and the information bits 305 to obtain a quantity of parity bits 315. The quantity of parity bits 315 may be concatenated with the information bits 305 (e.g., with one or more portions of the information bits 305) and the first shaping bits 310 to obtain a fourth set of bits. For example, the fourth set of bits (e.g., a component code 301-b and one or more other component codes that may have been encoded) may include the information bits 305, the first shaping bits 310, and the parity bits 315. In some examples, the first shaping bits 310 and the parity bits 315 may be concatenated with the LSB 335-c. In some examples, the first communication device may perform bit to symbol mapping (e.g., at 355) in which the fourth set of bits (e.g., of length N) may be mapped to a quantity of symbols (e.g., length N symbols). In some examples, the first communication device may map the fourth set of bits to the quantity of symbols according to a shaping order (e.g., associated with the fourth set of bits).

In some examples, the network may configure the first communication device (or the first communication device may be otherwise configured) with one or more parameters for the staircase encoding (e.g., for staircase component code). For example, the network may indicate, to the first communication device, a code block length configuration (N,K) for the staircase encoding (e.g., for a staircase component code, such as the component code 301-a). In some examples, the first communication device may use the block length configuration to determine a structure of the staircase code (e.g., a size of a code block (Bᵢ) and, as such, a size of the staircase block). For example, the parameter N may correspond to the size of the code block (Bᵢ) and the parameter K may correspond to the quantity the first shaping bits 310 to be included in a subsequent code block (Bᵢ₊₁). In some examples, the parameter N may be represented as N=2m. Additionally, or alternatively, the network may configure the first communication device (or the first communication device may be otherwise configured) with a transmission block length configuration (e.g., a configuration associated with a code block to be transmitted) and an FEC code rate (e.g., R_{c}).

In some examples, the network may configure the first communication device (or the first communication device may be otherwise configured) with a shaping block configuration. For example, the network may indicate, to the first communication device, a quantity of component codes (e.g., including the component code 301-a) to be shaped (e.g., per iteration). In some examples, the first communication device may determine the quantity of component codes to be shaped (e.g., per iteration) based on the parameter N(e.g., N=2m). For example, the first communication device may determine the quantity of component codes (M) in accordance with the following Equation 8:

$$mod ( m , M ) = 0. \qquad ( 8 )$$

In such an example, the first communication device may perform the channel decoding (e.g., using the channel decoder 325) based on the parameter M. Additionally, or alternatively, in some examples, the parameter M (e.g., determined in accordance with Equation 8) may provide for an equal dividend of component code groups (e.g., sets of multiple component codes). For example, based on the parameter M, a shaping block (e.g., the quantity of component codes used for shaping) may include a component code (e.g., M=1) or a set of multiple component codes (e.g., M>1). That is, based on a value of the parameter M, the first communication device may perform shaping per component code (e.g., using the component code 301) or per component code group (e.g., using the set of multiple component codes that includes the component code 301). Additionally, or alternatively, the network may configure the first communication device (or the first communication device may be otherwise configured) with a coding rate configuration for the component code 301-a (e.g., a shaping codeword). For example, the network may indicate, to the first communication device, a coding rate (e.g., a rate associated with the channel decoder 325, a distribution matching rate (R_{S})) to be used for the component code 301-a. In some examples, the first communication device may determine a quantity of shaping bits to be obtained (e.g., per shaping block) based on the coding rate.

In some examples, the shaping block (e.g., the quantity of component codes to be shaped) may include a quantity of bits (e.g., MN bits). In such examples, a quantity of symbols (e.g., modulated symbols to which the bits may be mapped) may depend on the quantity of bits included in the shaping block. For example, the quantity of symbols (N_{sym}) may be determined in accordance with the following Equation 9:

$${N}_{sym} = ⌈ MN / Q ⌉ \qquad ( 9 )$$

in which Q may correspond to a quantity of bits to be mapped (e.g., carried by) per symbol. Additionally, or alternatively, in some examples, the quantity of shaping bits (e.g., a length of a shaping bit sequence (K_{S})) may be determined in accordance with the following Equation 10:

$${K}_{s} = {N}_{sym} {R}_{s} . \qquad ( 10 )$$

In such examples, a quantity of bits include in the shaping block (e.g., carried per shaping block, Kᵢ bits) may be determined in accordance with the following Equation 11:

$${K}_{i} = MK - {K}_{s} . \qquad ( 11 )$$

In some examples, using the second shaping bits 330 as input for the subsequent code block 335 (e.g., placing the second shaping bits 330 at the subsequent code block 335) may enable the shaping operation (e.g., using the channel decoder 325) to be performed in parallel with the FEC encoding (e.g., using the FEC encoder 350). That is, the second shaping bits 330 may be obtained prior to FEC encoding or concurrently with (e.g., in parallel with) the FEC encoding. In some examples, performing channel decoding (e.g., the shaping operation) in parallel with the FEC encoding may enable reduce processing latency (e.g., due to the FEC and shaping being performed in parallel).

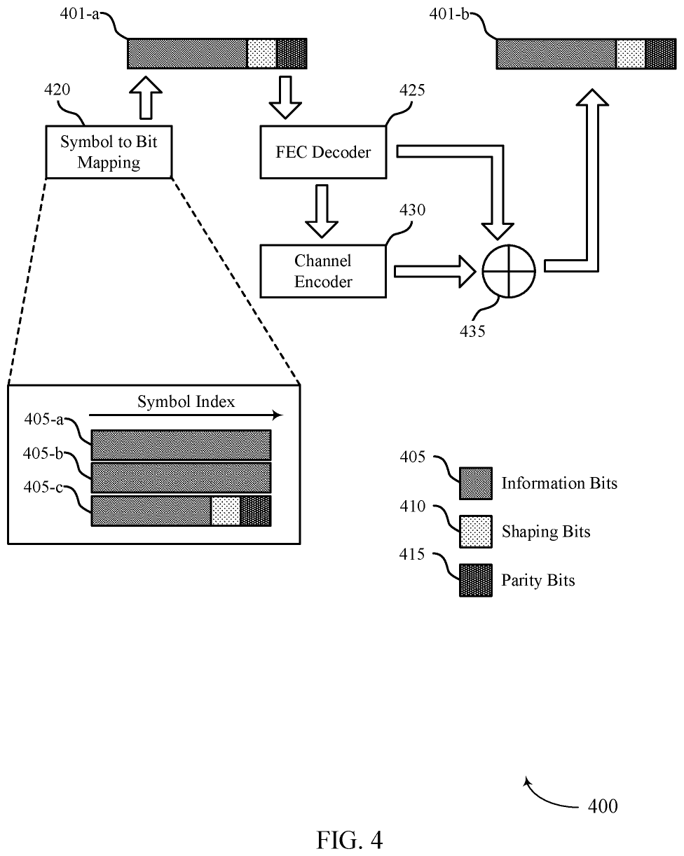

FIG. 4 illustrates an example of a staircase decoding scheme 400 that supports techniques for staircase encoding with block-code-based shaping in accordance with one or more aspects of the present disclosure. In some examples, the staircase decoding scheme 400 may implement aspects of the wireless communications system 100, the wireless communications system 200, and the staircase encoding scheme 300. For example, the staircase decoding scheme 400 may be implemented at a communication device, which may be an example of a device as described with reference to FIGS. 1 through 3.

In some examples, one or more communication devices (e.g., wireless devices) may support techniques for staircase code with block-code-based shaping. For example, a second communication device (e.g., a receiving device) may support techniques for staircase decoding using block-code-based shaping. In some examples, the second communication device may receive a set of symbols (e.g., a symbol sequence) from a first communication device (e.g., a transmitting device). In response, the second communication device may perform a staircase decoding procedure using the set of symbols. For example, during a current step of the staircase decoding procedure, the second communication device may perform a symbol to bit mapping operation (e.g., at 420) to obtain a first set of bits (e.g., a component code 401-a) for the current step of the staircase decoding procedure. The component code 401-a may include a quantity of sign bits (e.g., sign bits 405-a), a quantity of MSB (e.g., MSB 405-b), and a quantity of LSB (e.g., LSB 405-c). Additionally, or alternatively, a quantity of shaping bits 410 and a quantity of parity bits 415 may be concatenated with the LSB 405-c.

In some examples, the second communication device may perform an FEC decoding procedure (e.g., using an FEC decoder 425) on the first set of bits to obtain the quantity of shaping bits 410 and a second quantity of bits (e.g., shaped information bits). The second communication device may input the quantity of shaping bits 410 into the channel encoder 430 to obtain a third quantity of bits (e.g. to obtain a shaping codeword). Additionally, or alternatively, the communication device may perform a bit-masking operation (e.g., at the XOR operator at 435) using the third set of bits (e.g., and the quantity of shaping bits 410) to obtain a fourth quantity of bits (e.g., a component code 401-b). In some examples, performing staircase decoding with code-block-based shaping may improve a reliability with which the second communication device to obtain source information (e.g., a set of information bits) from the received set of symbols.

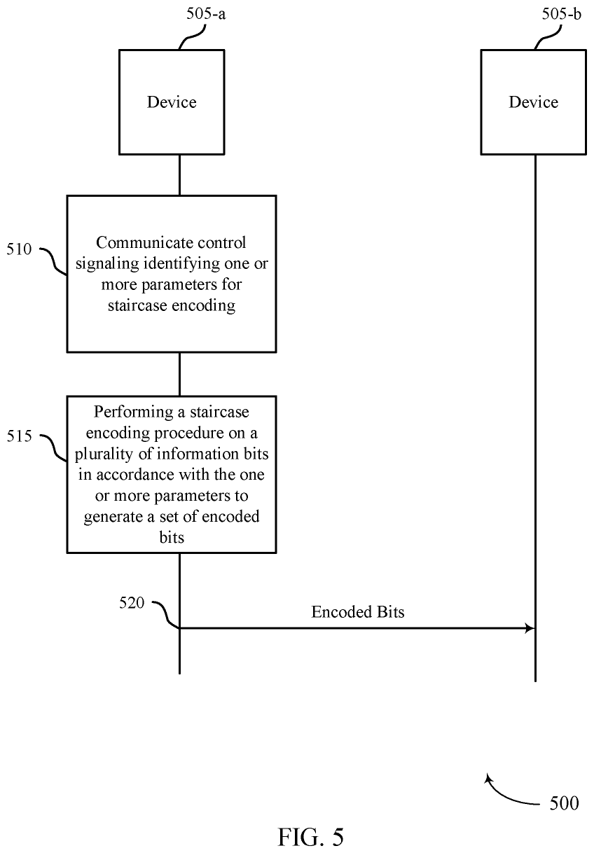

FIG. 5 illustrates an example of a process flow 500 that supports techniques for staircase encoding with block-code-based shaping in accordance with one or more aspects of the present disclosure. In some examples, the process flow 500 may implement aspects of the wireless communications system 100, the wireless communications system 200, the staircase encoding scheme 300, and the staircase decoding scheme 400. For example, the process flow 500 may be implemented at a device 505-a and a device 505-b, which may examples of a device as described with reference to FIGS. 1 through 4. In the example of FIG. 5, the device 505-a may be a transmitting device (e.g., an encoding device) and the device 505-b may be a receiving device (e.g., a decoding device).

At 510, the device 05-a may communicate (e.g., transmit or receive) control signaling (e.g., RRC signaling) identifying one or more parameters for staircase encoding. In some examples, the one or more parameters may be examples of parameters as described throughout the present disclosure, including with reference to FIG. 3. For example, the one or more parameters may indicate a size of the code block, a transmission block length, an FEC code rate, a quantity of component codes (e.g., to be shaped per iteration), a quantity of bits to be mapped, and a length of a shaping bit sequence, among other examples.

At 515, the device 505-a may perform a staircase encoding procedure on a set of multiple information bits in accordance with the one or more parameters to generate a set of encoded bits. The staircase encoding procedure may be an example of a staircase encoding procedure as described throughout the present disclosure, including with reference to FIG. 3. For example, the staircase encoding procedure, at a current step, may include concatenating a first set of shaping bits with a first set of information bits to generate a second set of bits. In some examples, the first set of shaping bits may be associated with shaping of a first set of bits from a previous step of the staircase encoding procedure. Additionally, or alternatively, the first set of information bits may be associated with the current step of the staircase encoding procedure.

In some examples, at the current step, the device 505-a may perform a channel decoding procedure on the second set of bits to generate a second set of shaping bits to be used in a subsequent step of the staircase encoding procedure. Additionally, or alternatively, the device 505-a may perform an FEC encoding procedure on a third set of bits to generate a set of parity bits. In some examples, the third set of bits may be based on the second set of bits. For example, the third set of bits may be output from an encoding procedure (e.g., a polar encoding procedure) performed on the second set of bits.

In some examples, at the current step, the device 505-a may map the third set of bits and the set of parity bits to a set of symbols to generate a fourth set of bits for the subsequent step of the staircase encoding procedure. At 520, the device 505-a may transmit the set of encoded bits to the device 505-b.

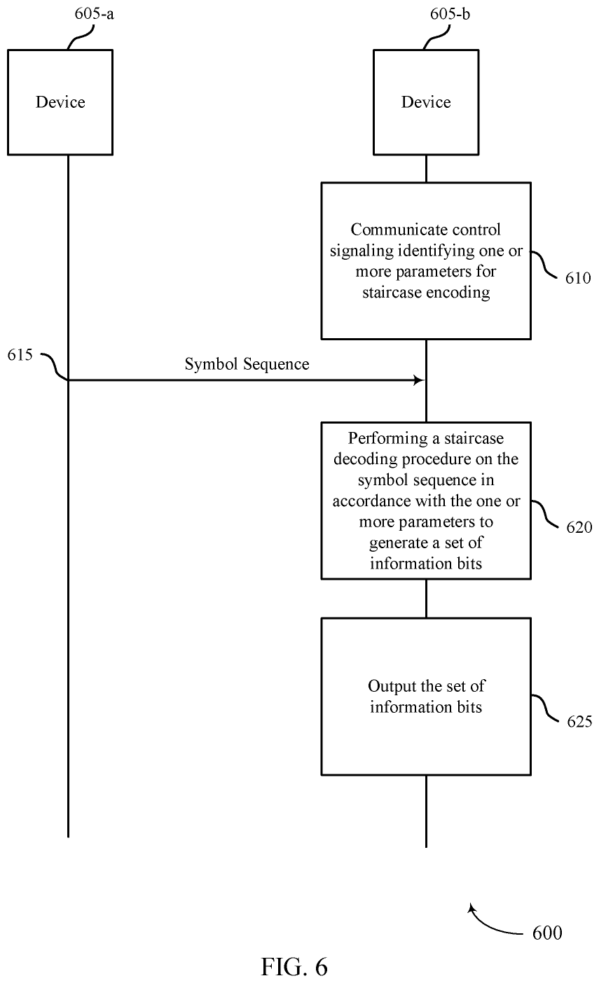

FIG. 6 illustrates an example of a process flow 600 that supports techniques for staircase encoding with block-code-based shaping in accordance with one or more aspects of the present disclosure. In some examples, the process flow 600 may implement aspects of the wireless communications system 100, the wireless communications system 200, the staircase encoding scheme 300, the staircase decoding scheme 400, and the process flow 500. For example, the process flow 600 may be implemented at a device 605-a and a device 605-b, which may examples of a device as described with reference to FIGS. 1 through 5. In the example of FIG. 6, the device 605-a may be a transmitting device (e.g., an encoding device) and the device 605-b may be a receiving device (e.g., a decoding device).

At 610, the device 605-b may communicate (e.g., transmit or receive) control signaling (e.g., RRC signaling) identifying one or more parameters for staircase decoding. In some examples, the one or more parameters may be examples of parameters as described throughout the present disclosure, including with reference to FIGS. 3 through 5. For example, the one or more parameters may indicate a size of the code block, a transmission block length, an FEC code rate, a quantity of component codes (e.g., to be shaped per iteration), a quantity of bits to be mapped, and a length of a shaping bit sequence, among other examples.

At 615, the device 605-b may receive a symbol sequence (e.g., a set of symbols) from the device 605-a. The symbol sequence may be an example of a symbol sequence as described throughout the present disclosure including with reference to FIG. 4. For example, the symbol sequence may be generated using a staircase encoding procedure with block-code-based shaping.

At 620, the device 605-b may perform a staircase decoding procedure on the symbol sequence in accordance with the one or more parameters to generate a set of information bits. The staircase decoding procedure may be an example of a staircase decoding procedure as described throughout the present disclosure including with reference to FIG. 4. For example, the staircase decoding procedure, at a current step, may include mapping the set of symbols to a first set of bits for the current step of the staircase decoding procedure. Additionally, or alternatively, at the current step of the staircase decoding procedure, the device 605-b may perform an FEC decoding procedure on the first set of bits to generate a set of shaping bits and a second set of bits to be used in the current step of the staircase decoding procedure. In some examples, at the current step of the staircase decoding procedure, the device 605-b may perform a bit-masking procedure on the second set of bits to generate a third set bits to be used in a subsequent step of the staircase decoding procedure. The bit-masking procedure may be based on the set of shaping bits.

At 625, the device 605-b may output the set of information bits. In some examples, decoding the symbol sequence (e.g., received at 615) using the staircase decoding procedure with block-code-based shaping may improve a reliability with which the device 605-b may obtain source information (e.g., the set of information bits) from the received symbol sequence, among other possible benefits.

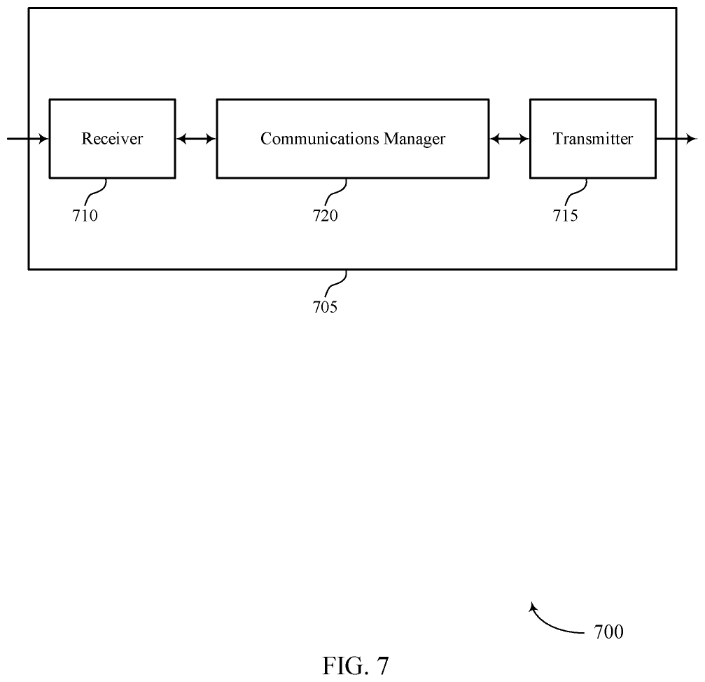

FIG. 7 shows a block diagram 700 of a device 705 that supports techniques for staircase encoding with block-code-based shaping in accordance with one or more aspects of the present disclosure. The device 705 may be an example of aspects of a UE 115 or a network entity 105 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for staircase encoding with block-code-based shaping). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for staircase encoding with block-code-based shaping). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of techniques for staircase encoding with block-code-based shaping as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a first wireless device (e.g., the device 705) in accordance with examples as disclosed herein. For example, the communications manager 720 may be configured as or otherwise support a means for communicating control signaling identifying one or more parameters for staircase encoding. The communications manager 720 may be configured as or otherwise support a means for performing, in accordance with the one or more parameters, a staircase encoding procedure on a set of multiple information bits to generate a set of encoded bits. The staircase encoding procedure, at a current step, including concatenating a first set of shaping bits with a first set of information bits to generate a second set of bits, the first set of shaping bits associated with shaping a first set of bits from a previous step of the staircase encoding procedure, and the first set of information bits for the current step. The communications manager 720 may be configured as or otherwise support a means for performing a channel decoding procedure on the second set of bits to generate a second set of shaping bits to be used in a subsequent step of the staircase encoding procedure. The communications manager 720 may be configured as or otherwise support a means for performing an FEC encoding procedure on a third set of bits to generate a set of parity bits, the third set of bits being based on the second set of bits. The communications manager 720 may be configured as or otherwise support a means for mapping the third set of bits and the set of parity bits to a set of symbols to generate a fourth set of bits for the subsequent step of the staircase encoding procedure. The communications manager 720 may be configured as or otherwise support a means for transmitting the set of encoded bits to a second wireless device (e.g., another device 705).

By including or configuring the communications manager 720 in accordance with examples as described herein, the device 705 (e.g., a processor controlling or otherwise coupled with the receiver 710, the transmitter 715, the communications manager 720, or a combination thereof) may support techniques for reduced processing.

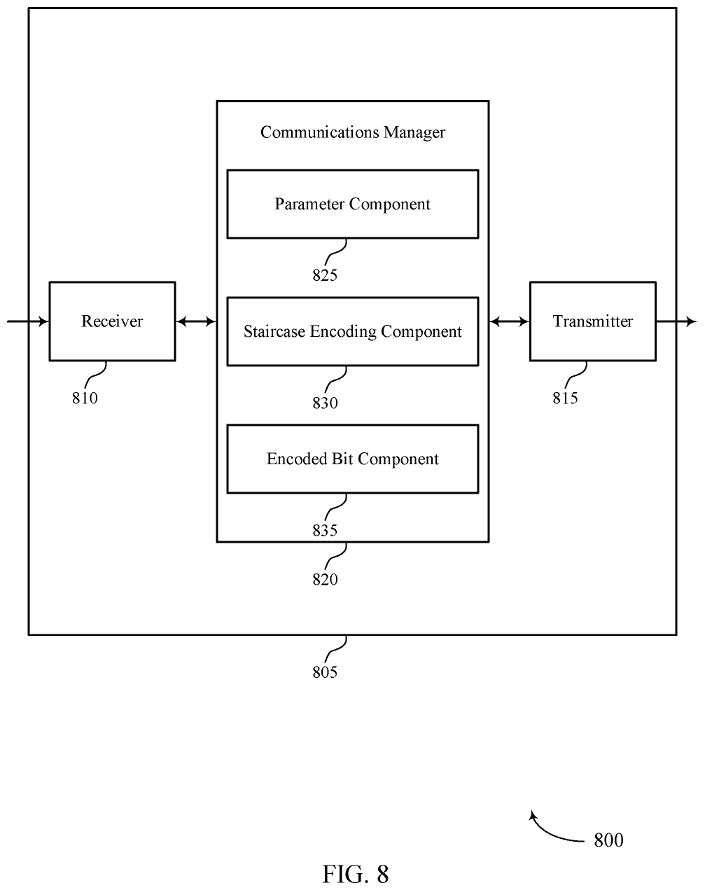

FIG. 8 shows a block diagram 800 of a device 805 that supports techniques for staircase encoding with block-code-based shaping in accordance with one or more aspects of the present disclosure. The device 805 may be an example of aspects of a device 705, a UE 115, or a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for staircase encoding with block-code-based shaping). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for staircase encoding with block-code-based shaping). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of techniques for staircase encoding with block-code-based shaping as described herein. For example, the communications manager 820 may include a parameter component 825, a staircase encoding component 830, an encoded bit component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a first wireless device (e.g., the device 805) in accordance with examples as disclosed herein. The parameter component 825 may be configured as or otherwise support a means for communicating control signaling identifying one or more parameters for staircase encoding. The staircase encoding component 830 may be configured as or otherwise support a means for performing, in accordance with the one or more parameters, a staircase encoding procedure on a set of multiple information bits to generate a set of encoded bits. The staircase encoding procedure, at a current step, including concatenating a first set of shaping bits with a first set of information bits to generate a second set of bits, the first set of shaping bits associated with shaping a first set of bits from a previous step of the staircase encoding procedure, and the first set of information bits for the current step. The staircase encoding component 830 may be configured as or otherwise support a means for performing a channel decoding procedure on the second set of bits to generate a second set of shaping bits to be used in a subsequent step of the staircase encoding procedure. The staircase encoding component 830 may be configured as or otherwise support a means for performing an FEC encoding procedure on a third set of bits to generate a set of parity bits, the third set of bits being based on the second set of bits. The staircase encoding component 830 may be configured as or otherwise support a means for mapping the third set of bits and the set of parity bits to a set of symbols to generate a fourth set of bits for the subsequent step of the staircase encoding procedure. The encoded bit component 835 may be configured as or otherwise support a means for transmitting the set of encoded bits to a second wireless device (e.g., another device 805).

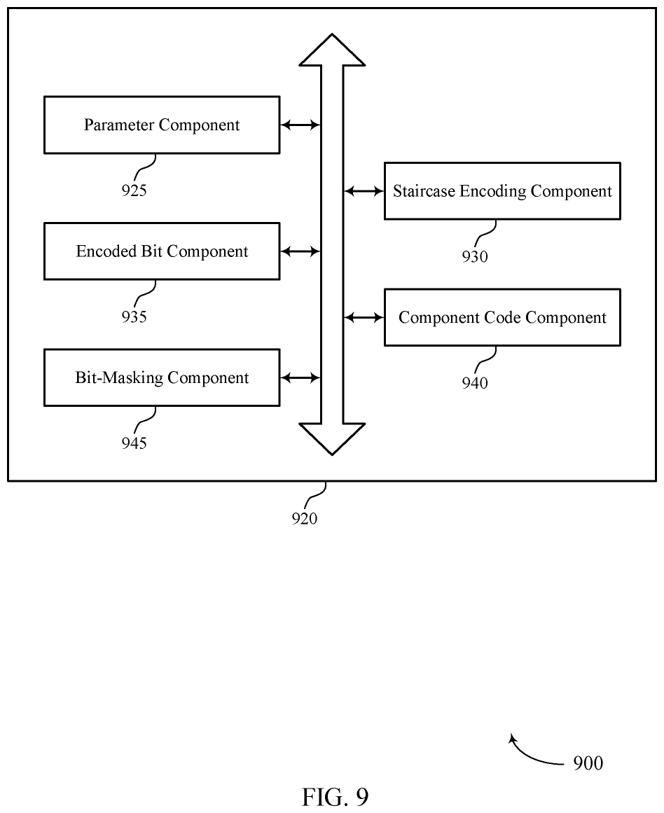

FIG. 9 shows a block diagram 900 of a communications manager 920 that supports techniques for staircase encoding with block-code-based shaping in accordance with one or more aspects of the present disclosure. The communications manager 920 may be an example of aspects of a communications manager 720, a communications manager 820, or both, as described herein. The communications manager 920, or various components thereof, may be an example of means for performing various aspects of techniques for staircase encoding with block-code-based shaping as described herein. For example, the communications manager 920 may include a parameter component 925, a staircase encoding component 930, an encoded bit component 935, a component code component 940, a bit-masking component 945, or any combination thereof. Each of these components may communicate, directly or indirectly, with one another (e.g., via one or more buses).

The communications manager 920 may support wireless communication at a first wireless device (e.g., a UE, a network entity) in accordance with examples as disclosed herein. The parameter component 925 may be configured as or otherwise support a means for communicating control signaling identifying one or more parameters for staircase encoding. The staircase encoding component 930 may be configured as or otherwise support a means for performing, in accordance with the one or more parameters, a staircase encoding procedure on a set of multiple information bits to generate a set of encoded bits. The staircase encoding procedure, at a current step, including concatenating a first set of shaping bits with a first set of information bits to generate a second set of bits, the first set of shaping bits associated with shaping a first set of bits from a previous step of the staircase encoding procedure, and the first set of information bits for the current step. In some examples, the staircase encoding component 930 may be configured as or otherwise support a means for performing a channel decoding procedure on the second set of bits to generate a second set of shaping bits to be used in a subsequent step of the staircase encoding procedure. In some examples, the staircase encoding component 930 may be configured as or otherwise support a means for performing an FEC encoding procedure on a third set of bits to generate a set of parity bits, the third set of bits being based on the second set of bits. In some examples, the staircase encoding component 930 may be configured as or otherwise support a means for mapping the third set of bits and the set of parity bits to a set of symbols to generate a fourth set of bits for the subsequent step of the staircase encoding procedure. The encoded bit component 935 may be configured as or otherwise support a means for transmitting the set of encoded bits to a second wireless device (e.g., another UE, another network entity).

In some examples, to support communicating the control signaling identifying the one or more parameters for staircase encoding, the parameter component 925 may be configured as or otherwise support a means for communicating an indication of a length of each code block of a set of multiple code blocks to be used for staircase encoding, where the second set of bits is based on the length.

In some examples, the component code component 940 may be configured as or otherwise support a means for determining, based on the length of each code block, a quantity of component codes to be used for channel decoding, where performing the channel decoding procedure is based on the quantity of component codes.

In some examples, to support communicating the control signaling identifying the one or more parameters for staircase encoding, the parameter component 925 may be configured as or otherwise support a means for communicating an indication of a coding rate to be used for staircase encoding, where the second set of shaping bits is based on the coding rate. In some examples, the second set of shaping bits is further based as least in part on a quantity of bits to be carried by each symbol of the set of symbols.

In some examples, to support communicating the control signaling identifying the one or more parameters for staircase encoding, the parameter component 925 may be configured as or otherwise support a means for communicating an indication of a quantity of component codes to be used for channel decoding, where the channel decoding procedure is performed using one or more component codes based on the quantity of component codes.

In some examples, the channel decoding procedure and the FEC encoding procedure are performed concurrently at least in part. In some examples, the FEC encoding procedure is performed subsequently to the channel decoding procedure.

In some examples, to support performing the staircase encoding procedure, the staircase encoding component 930 may be configured as or otherwise support a means for performing a channel encoding procedure using the second set of bits to generate the third set of bits, where performing the FEC encoding procedure is based on the channel encoding procedure. In some examples, the third set of bits includes cover code bits.

In some examples, the bit-masking component 945 may be configured as or otherwise support a means for performing a bit-masking procedure on a portion of the third set of bits, to obtain a shaped portion of the third set of bits, where the FEC encoding procedure is further based on the bit-masking procedure.

In some examples, the first wireless device includes a UE and, to support communicating the control signaling identifying the one or more parameters for staircase encoding, the parameter component 925 may be configured as or otherwise support a means for receiving the control signaling identifying the one or more parameters for staircase encoding, where performing the staircase encoding procedure is based on receiving the control signaling.

In some examples, the first wireless device includes a network entity and, to support communicating the control signaling identifying the one or more parameters for staircase encoding, the parameter component 925 may be configured as or otherwise support a means for transmitting the control signaling identifying the one or more parameters for staircase encoding, where performing the staircase encoding procedure is based on transmitting the control signaling. In some examples, the channel decoding procedure is performed using a polar decoder.

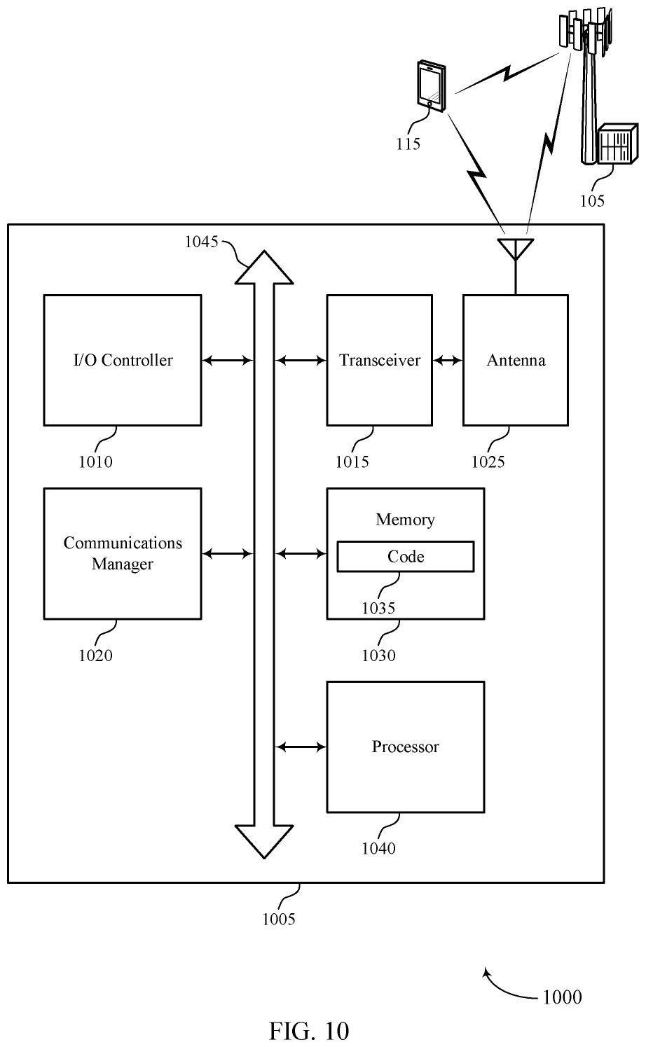

FIG. 10 shows a diagram of a system 1000 including a device 1005 that supports techniques for staircase encoding with block-code-based shaping in accordance with one or more aspects of the present disclosure. The device 1005 may be an example of or include the components of a device 705, a device 805, a UE 115, or a network entity 105 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting techniques for staircase encoding with block-code-based shaping). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a first wireless device (e.g., the device 1005) in accordance with examples as disclosed herein. For example, the communications manager 1020 may be configured as or otherwise support a means for communicating control signaling identifying one or more parameters for staircase encoding. The communications manager 1020 may be configured as or otherwise support a means for performing, in accordance with the one or more parameters, a staircase encoding procedure on a set of multiple information bits to generate a set of encoded bits. The staircase encoding procedure, at a current step, including concatenating a first set of shaping bits with a first set of information bits to generate a second set of bits, the first set of shaping bits associated with shaping a first set of bits from a previous step of the staircase encoding procedure, and the first set of information bits for the current step. The communications manager 1020 may be configured as or otherwise support a means for performing a channel decoding procedure on the second set of bits to generate a second set of shaping bits to be used in a subsequent step of the staircase encoding procedure. The communications manager 1020 may be configured as or otherwise support a means for performing an FEC encoding procedure on a third set of bits to generate a set of parity bits, the third set of bits being based on the second set of bits. The communications manager 1020 may be configured as or otherwise support a means for mapping the third set of bits and the set of parity bits to a set of symbols to generate a fourth set of bits for the subsequent step of the staircase encoding procedure. The communications manager 1020 may be configured as or otherwise support a means for transmitting the set of encoded bits to a second wireless device.

By including or configuring the communications manager 1020 in accordance with examples as described herein, the device 1005 may support techniques for improved communication reliability, reduced latency, improved user experience related to reduced processing, and improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of techniques for staircase encoding with block-code-based shaping as described herein, or the processor 1040 and the memory 1030 may be otherwise configured to perform or support such operations.

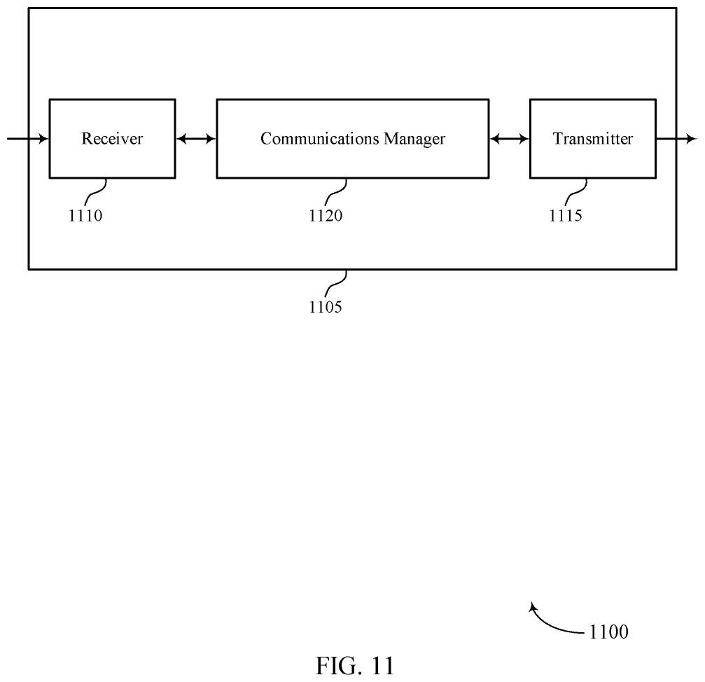

FIG. 11 shows a block diagram 1100 of a device 1105 that supports techniques for staircase encoding with block-code-based shaping in accordance with one or more aspects of the present disclosure. The device 1105 may be an example of aspects of a network entity 105 or a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of techniques for staircase encoding with block-code-based shaping as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a second wireless device (e.g., the device 1105) in accordance with examples as disclosed herein. For example, the communications manager 1120 may be configured as or otherwise support a means for communicating control signaling identifying one or more parameters for staircase decoding. The communications manager 1120 may be configured as or otherwise support a means for receiving a set of symbols from a first wireless device (e.g., another device 1105). The communications manager 1120 may be configured as or otherwise support a means for performing, in accordance with the one or more parameters, a staircase decoding procedure on the set of symbols to generate a set of information bits. The staircase decoding procedure, at a current step, including mapping the set of symbols to a first set of bits for the current step of the staircase decoding procedure. The communications manager 1120 may be configured as or otherwise support a means for performing an FEC decoding procedure on the first set of bits to generate a set of shaping bits and a second set of bits to be used in the current step of the staircase decoding procedure. The communications manager 1120 may be configured as or otherwise support a means for performing a bit-masking procedure on the second set of bits to generate a third set bits to be used in a subsequent step of the staircase decoding procedure, the bit-masking procedure based on the set of shaping bits. The communications manager 1120 may be configured as or otherwise support a means for outputting the set of information bits.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for reduced processing.

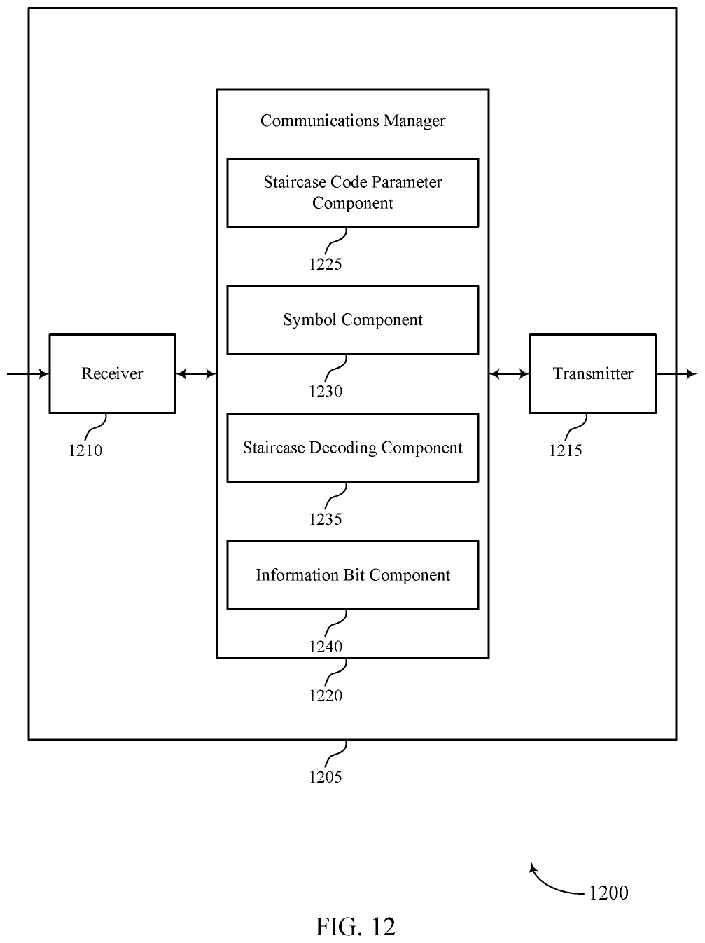

FIG. 12 shows a block diagram 1200 of a device 1205 that supports techniques for staircase encoding with block-code-based shaping in accordance with one or more aspects of the present disclosure. The device 1205 may be an example of aspects of a device 1105, a network entity 105, or a UE 115 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of techniques for staircase encoding with block-code-based shaping as described herein. For example, the communications manager 1220 may include a staircase code parameter component 1225, a symbol component 1230, a staircase decoding component 1235, an information bit component 1240, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a second wireless device (e.g., the device 1205) in accordance with examples as disclosed herein. The staircase code parameter component 1225 may be configured as or otherwise support a means for communicating control signaling identifying one or more parameters for staircase decoding. The symbol component 1230 may be configured as or otherwise support a means for receiving a set of symbols from a first wireless device (e.g., another device 1205). The staircase decoding component 1235 may be configured as or otherwise support a means for performing, in accordance with the one or more parameters, a staircase decoding procedure on the set of symbols to generate a set of information bits. The staircase decoding procedure, at a current step, including mapping the set of symbols to a first set of bits for the current step of the staircase decoding procedure. The staircase decoding component 1235 may be configured as or otherwise support a means for performing an FEC decoding procedure on the first set of bits to generate a set of shaping bits and a second set of bits to be used in the current step of the staircase decoding procedure. The staircase decoding component 1235 may be configured as or otherwise support a means for performing a bit-masking procedure on the second set of bits to generate a third set bits to be used in a subsequent step of the staircase decoding procedure, the bit-masking procedure based on the set of shaping bits. The information bit component 1240 may be configured as or otherwise support a means for outputting the set of information bits.

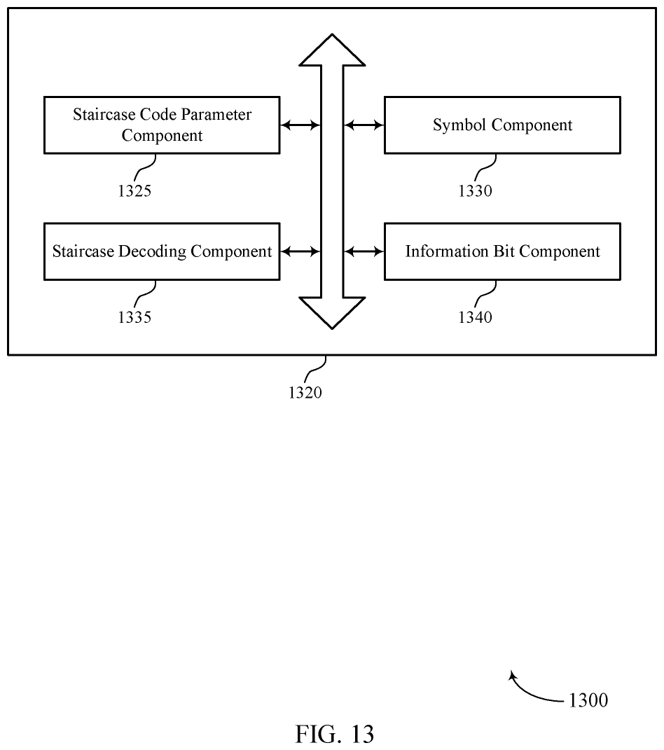

FIG. 13 shows a block diagram 1300 of a communications manager 1320 that supports techniques for staircase encoding with block-code-based shaping in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of techniques for staircase encoding with block-code-based shaping as described herein. For example, the communications manager 1320 may include a staircase code parameter component 1325, a symbol component 1330, a staircase decoding component 1335, an information bit component 1340, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at a second wireless device (e.g., a UE 115, a network entity 105) in accordance with examples as disclosed herein. The staircase code parameter component 1325 may be configured as or otherwise support a means for communicating control signaling identifying one or more parameters for staircase decoding. The symbol component 1330 may be configured as or otherwise support a means for receiving a set of symbols from a first wireless device (e.g., another UE 115, another network entity 105). The staircase decoding component 1335 may be configured as or otherwise support a means for performing, in accordance with the one or more parameters, a staircase decoding procedure on the set of symbols to generate a set of information bits. The staircase decoding procedure, at a current step, including mapping the set of symbols to a first set of bits for the current step of the staircase decoding procedure. In some examples, the staircase decoding component 1335 may be configured as or otherwise support a means for performing an FEC decoding procedure on the first set of bits to generate a set of shaping bits and a second set of bits to be used in the current step of the staircase decoding procedure. In some examples, the staircase decoding component 1335 may be configured as or otherwise support a means for performing a bit-masking procedure on the second set of bits to generate a third set bits to be used in a subsequent step of the staircase decoding procedure, the bit-masking procedure based on the set of shaping bits. The information bit component 1340 may be configured as or otherwise support a means for outputting the set of information bits.

In some examples, to support communicating the control signaling identifying the one or more parameters for staircase encoding, the staircase code parameter component 1325 may be configured as or otherwise support a means for communicating an indication of a length of each code block of a set of multiple code blocks to be used for staircase decoding, where the second set of bits is based on the length.

In some examples, to support communicating the control signaling identifying the one or more parameters for staircase decoding, the staircase code parameter component 1325 may be configured as or otherwise support a means for communicating an indication of a coding rate to be used for staircase decoding, where the set of shaping bits is based on the coding rate. In some examples, the set of shaping bits is further based as least in part on a quantity of bits carried by each symbol of the set of symbols.

In some examples, to support communicating the control signaling identifying the one or more parameters for staircase decoding, the staircase code parameter component 1325 may be configured as or otherwise support a means for communicating an indication of a quantity of component codes to be used for staircase decoding, where the staircase decoding procedure is based on the quantity of component codes.

In some examples, to support performing the staircase decoding procedure, the staircase decoding component 1335 may be configured as or otherwise support a means for performing a channel encoding procedure on the set of shaping bits, where the bit-masking procedure is based on performing the channel encoding procedure.

In some examples, the second wireless device includes a UE and, to support communicating the control signaling identifying the one or more parameters for staircase encoding, the staircase code parameter component 1325 may be configured as or otherwise support a means for receiving the control signaling identifying the one or more parameters for staircase decoding, where performing the staircase decoding procedure is based on receiving the control signaling.

In some examples, the second wireless device includes a network entity and, to support communicating the control signaling identifying the one or more parameters for staircase decoding, the staircase code parameter component 1325 may be configured as or otherwise support a means for transmitting the control signaling identifying the one or more parameters for staircase decoding, where performing the staircase decoding procedure is based on transmitting the control signaling.

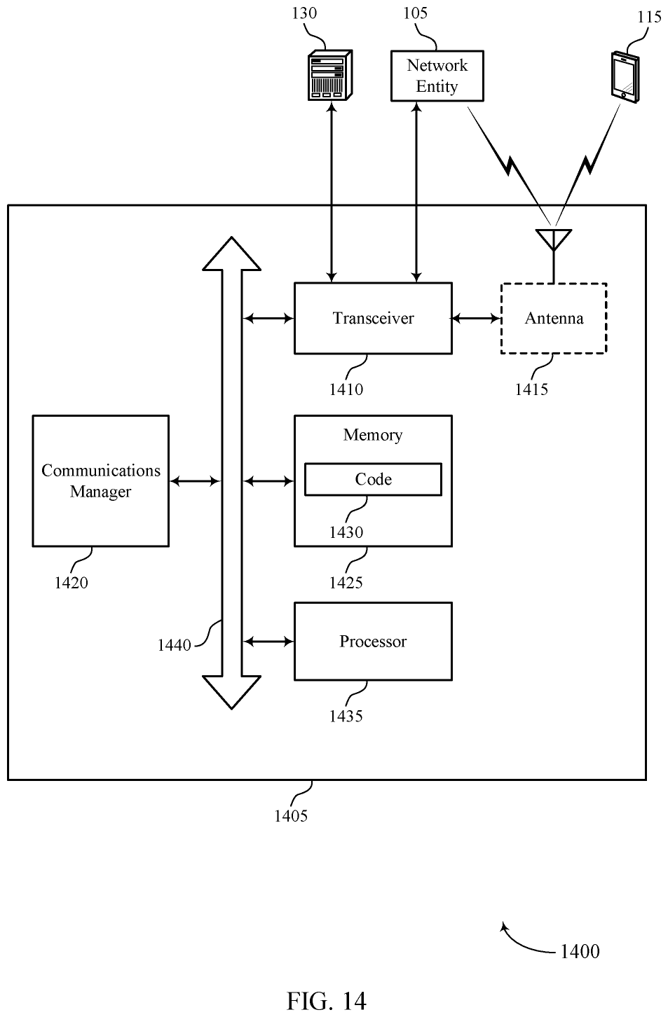

FIG. 14 shows a diagram of a system 1400 including a device 1405 that supports techniques for staircase encoding with block-code-based shaping in accordance with one or more aspects of the present disclosure. The device 1405 may be an example of or include the components of a device 1105, a device 1205, a network entity 105, or a UE 115 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting techniques for staircase encoding with block-code-based shaping). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405.

The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication at a second wireless device (e.g., the device 1405) in accordance with examples as disclosed herein. For example, the communications manager 1420 may be configured as or otherwise support a means for communicating control signaling identifying one or more parameters for staircase decoding. The communications manager 1420 may be configured as or otherwise support a means for receiving a set of symbols from a first wireless device (e.g., another device 1405). The communications manager 1420 may be configured as or otherwise support a means for performing, in accordance with the one or more parameters, a staircase decoding procedure on the set of symbols to generate a set of information bits. The staircase decoding procedure, at a current step, including mapping the set of symbols to a first set of bits for the current step of the staircase decoding procedure. The communications manager 1420 may be configured as or otherwise support a means for performing an FEC decoding procedure on the first set of bits to generate a set of shaping bits and a second set of bits to be used in the current step of the staircase decoding procedure. The communications manager 1420 may be configured as or otherwise support a means for performing a bit-masking procedure on the second set of bits to generate a third set bits to be used in a subsequent step of the staircase decoding procedure, the bit-masking procedure based on the set of shaping bits. The communications manager 1420 may be configured as or otherwise support a means for outputting the set of information bits.

By including or configuring the communications manager 1420 in accordance with examples as described herein, the device 1405 may support techniques for improved communication reliability, reduced latency, improved user experience related to reduced processing, and improved utilization of processing capability.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of techniques for staircase encoding with block-code-based shaping as described herein, or the processor 1435 and the memory 1425 may be otherwise configured to perform or support such operations.

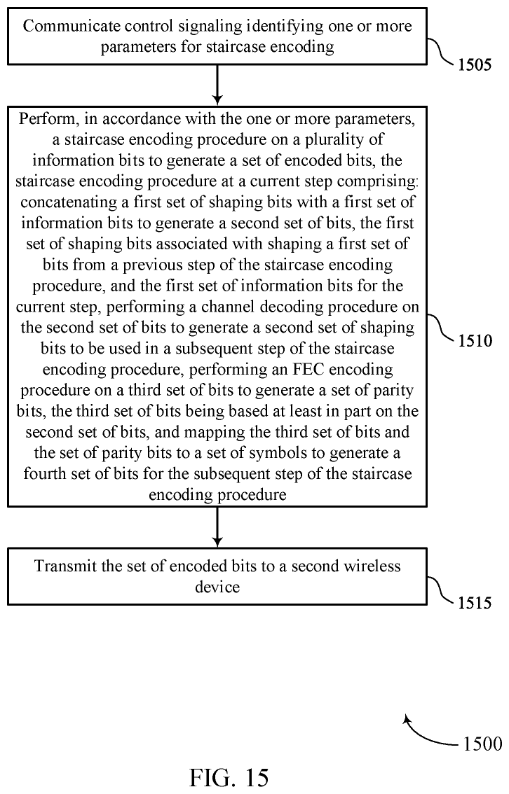

FIG. 15 shows a flowchart illustrating a method 1500 that supports techniques for staircase encoding with block-code-based shaping in accordance with one or more aspects of the present disclosure. The operations of the method 1500 may be implemented by a UE or a network entity or respective components of a UE or a network entity as described herein. For example, the operations of the method 1500 may be performed by a device (e.g., a UE 115 or a network entity 105) as described with reference to FIGS. 1 through 10. In some examples, a device may execute a set of instructions to control the functional elements of the device to perform the described functions. Additionally, or alternatively, the UE may perform aspects of the described functions using special-purpose hardware.

At 1505, the method may include communicating control signaling identifying one or more parameters for staircase encoding. The operations of 1505 may be performed in accordance with examples as disclosed herein. In some examples, aspects of the operations of 1505 may be performed by a parameter component 925 as described with reference to FIG. 9.

At 1510, the method may include performing, in accordance with the one or more parameters, a staircase encoding procedure on a set of multiple information bits to generate a set of encoded bits, the staircase encoding procedure at a current step including: concatenating a first set of shaping bits with a first set of information bits to generate a second set of bits, the first set of shaping bits associated with shaping a first set of bits from a previous step of the staircase encoding procedure, and the first set of information bits for the current step, performing a channel decoding procedure on the second set of bits to generate a second set of shaping bits to be used in a subsequent step of the staircase encoding procedure, performing an FEC encoding procedure on a third set of bits to generate a set of parity bits, the third set of bits being based on the second set of bits, and mapping the third set of bits and the set of parity bits to a set of symbols to generate a fourth set of bits for the subsequent step of the staircase encoding procedure. The operations of 1510 may be performed in accordance with examples as disclosed herein. In some examples, aspects of the operations of 1510 may be performed by a staircase encoding component 930 as described with reference to FIG. 9.

At 1515, the method may include transmitting the set of encoded bits to a second wireless device. The operations of 1515 may be performed in accordance with examples as disclosed herein. In some examples, aspects of the operations of 1515 may be performed by an encoded bit component 935 as described with reference to FIG. 9.

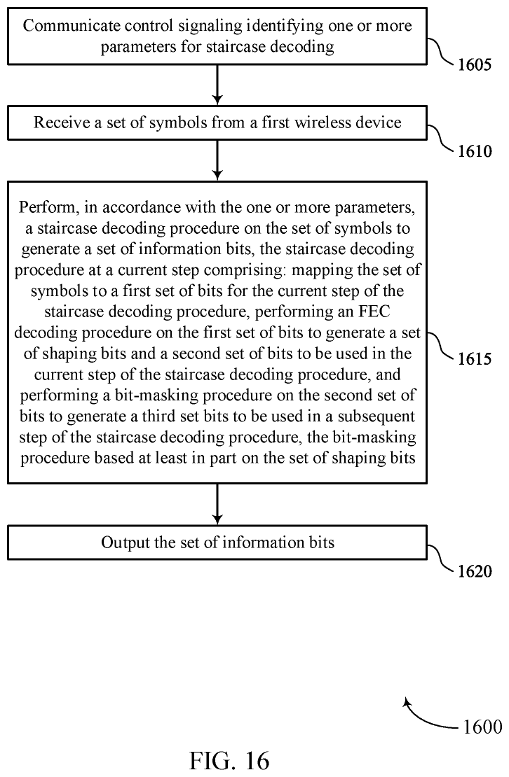

FIG. 16 shows a flowchart illustrating a method 1600 that supports techniques for staircase encoding with block-code-based shaping in accordance with one or more aspects of the present disclosure. The operations of the method 1600 may be implemented by a network entity or a UE or respective components of a network entity or a UE as described herein. For example, the operations of the method 1600 may be performed by a device (e.g., network entity or a UE) as described with reference to FIGS. 1 through 6 and 11 through 14. In some examples, a device may execute a set of instructions to control the functional elements of the network entity to perform the described functions. Additionally, or alternatively, the device may perform aspects of the described functions using special-purpose hardware.

At 1605, the method may include communicating control signaling identifying one or more parameters for staircase decoding. The operations of 1605 may be performed in accordance with examples as disclosed herein. In some examples, aspects of the operations of 1605 may be performed by a staircase code parameter component 1325 as described with reference to FIG. 13.

At 1610, the method may include receiving a set of symbols from a first wireless device. The operations of 1610 may be performed in accordance with examples as disclosed herein. In some examples, aspects of the operations of 1610 may be performed by a symbol component 1330 as described with reference to FIG. 13.

At 1615, the method may include performing, in accordance with the one or more parameters, a staircase decoding procedure on the set of symbols to generate a set of information bits, the staircase decoding procedure at a current step including: mapping the set of symbols to a first set of bits for the current step of the staircase decoding procedure, performing an FEC decoding procedure on the first set of bits to generate a set of shaping bits and a second set of bits to be used in the current step of the staircase decoding procedure, and performing a bit-masking procedure on the second set of bits to generate a third set bits to be used in a subsequent step of the staircase decoding procedure, the bit-masking procedure based on the set of shaping bits. The operations of 1615 may be performed in accordance with examples as disclosed herein. In some examples, aspects of the operations of 1615 may be performed by a staircase decoding component 1335 as described with reference to FIG. 13.

At 1620, the method may include outputting the set of information bits. The operations of 1620 may be performed in accordance with examples as disclosed herein. In some examples, aspects of the operations of 1620 may be performed by an information bit component 1340 as described with reference to FIG. 13.

The following provides an overview of aspects of the present disclosure:
Aspect 1: A method for wireless communication at a first wireless device, comprising: communicating control signaling identifying one or more parameters for staircase encoding; performing, in accordance with the one or more parameters, a staircase encoding procedure on a plurality of information bits to generate a set of encoded bits, the staircase encoding procedure at a current step comprising: concatenating a first set of shaping bits with a first set of information bits to generate a second set of bits, the first set of shaping bits associated with shaping a first set of bits from a previous step of the staircase encoding procedure, and the first set of information bits for the current step; performing a channel decoding procedure on the second set of bits to generate a second set of shaping bits to be used in a subsequent step of the staircase encoding procedure; performing a FEC encoding procedure on a third set of bits to generate a set of parity bits, the third set of bits being based at least in part on the second set of bits; and mapping the third set of bits and the set of parity bits to a set of symbols to generate a fourth set of bits for the subsequent step of the staircase encoding procedure; and transmitting the set of encoded bits to a second wireless device.
Aspect 2: The method of aspect 1, wherein communicating the control signaling identifying the one or more parameters for staircase encoding comprises: communicating an indication of a length of each code block of a plurality of code blocks to be used for staircase encoding, wherein the second set of bits is based at least in part on the length.
Aspect 3: The method of aspect 2, further comprising: determining, based at least in part on the length of each code block, a quantity of component codes to be used for channel decoding, wherein performing the channel decoding procedure is based at least in part on the quantity of component codes.
Aspect 4: The method of any of aspects 1 through 3, wherein communicating the control signaling identifying the one or more parameters for staircase encoding comprises: communicating an indication of a coding rate to be used for staircase encoding, wherein the second set of shaping bits is based at least in part on the coding rate.
Aspect 5: The method of aspect 4, wherein the second set of shaping bits is further based as least in part on a quantity of bits to be carried by each symbol of the set of symbols.
Aspect 6: The method of any of aspects 1 through 5, wherein communicating the control signaling identifying the one or more parameters for staircase encoding comprises: communicating an indication of a quantity of component codes to be used for channel decoding, wherein the channel decoding procedure is performed using one or more component codes based at least in part on the quantity of component codes.
Aspect 7: The method of any of aspects 1 through 6, wherein the channel decoding procedure and the FEC encoding procedure are performed concurrently at least in part.
Aspect 8: The method of any of aspects 1 through 6, wherein the FEC encoding procedure is performed subsequently to the channel decoding procedure.
Aspect 9: The method of any of aspects 1 through 8, wherein performing the staircase encoding procedure further comprises: performing a channel encoding procedure using the second set of bits to generate the third set of bits, wherein performing the FEC encoding procedure is based at least in part on the channel encoding procedure.
Aspect 10: The method of aspect 9, wherein the third set of bits comprises cover code bits.
Aspect 11: The method of any of aspects 9 through 10, further comprising: performing a bit-masking procedure on a portion of the third set of bits, to obtain a shaped portion of the third set of bits, wherein the FEC encoding procedure is further based at least in part on the bit-masking procedure.
Aspect 12: The method of any of aspects 9 through 11, the channel encoding procedure is performed using a polar encoder.
Aspect 13: The method of any of aspects 1 through 12, wherein the first wireless device comprises a UE and communicating the control signaling identifying the one or more parameters for staircase encoding comprises: receiving the control signaling identifying the one or more parameters for staircase encoding, wherein performing the staircase encoding procedure is based at least in part on receiving the control signaling.
Aspect 14: The method of any of aspects 1 through 12, wherein the first wireless device comprises a network entity and communicating the control signaling identifying the one or more parameters for staircase encoding comprises: transmitting the control signaling identifying the one or more parameters for staircase encoding, wherein performing the staircase encoding procedure is based at least in part on transmitting the control signaling.
Aspect 15: The method of any of aspects 1 through 14, wherein the channel decoding procedure is performed using a polar decoder.
Aspect 16: A method for wireless communication at a second wireless device, comprising: communicating control signaling identifying one or more parameters for staircase decoding; receiving a set of symbols from a first wireless device; performing, in accordance with the one or more parameters, a staircase decoding procedure on the set of symbols to generate a set of information bits, the staircase decoding procedure at a current step comprising: mapping the set of symbols to a first set of bits for the current step of the staircase decoding procedure; performing a FEC decoding procedure on the first set of bits to generate a set of shaping bits and a second set of bits to be used in the current step of the staircase decoding procedure; and performing a bit-masking procedure on the second set of bits to generate a third set bits to be used in a subsequent step of the staircase decoding procedure, the bit-masking procedure based at least in part on the set of shaping bits; and outputting the set of information bits.
Aspect 17: The method of aspect 16, wherein communicating the control signaling identifying the one or more parameters for staircase encoding comprises: communicating an indication of a length of each code block of a plurality of code blocks to be used for staircase decoding, wherein the second set of bits is based at least in part on the length.
Aspect 18: The method of any of aspects 16 through 17, wherein communicating the control signaling identifying the one or more parameters for staircase decoding comprises: communicating an indication of a coding rate to be used for staircase decoding, wherein the set of shaping bits is based at least in part on the coding rate.
Aspect 19: The method of aspect 18, wherein the set of shaping bits is further based as least in part on a quantity of bits carried by each symbol of the set of symbols.
Aspect 20: The method of any of aspects 16 through 19, wherein communicating the control signaling identifying the one or more parameters for staircase decoding comprises: communicating an indication of a quantity of component codes to be used for staircase decoding, wherein the staircase decoding procedure is based at least in part on the quantity of component codes.
Aspect 21: The method of any of aspects 16 through 20, wherein performing the staircase decoding procedure further comprises: performing a channel encoding procedure on the set of shaping bits, wherein the bit-masking procedure is based at least in part on performing the channel encoding procedure.
Aspect 22: The method of any of aspects 16 through 21, wherein the second wireless device comprises a UE and communicating the control signaling identifying the one or more parameters for staircase encoding comprises: receiving the control signaling identifying the one or more parameters for staircase decoding, wherein performing the staircase decoding procedure is based at least in part on receiving the control signaling.
Aspect 23: The method of any of aspects 16 through 21, wherein the second wireless device comprises a network entity and communicating the control signaling identifying the one or more parameters for staircase decoding comprises: transmitting the control signaling identifying the one or more parameters for staircase decoding, wherein performing the staircase decoding procedure is based at least in part on transmitting the control signaling.
Aspect 24: An apparatus for wireless communication at a first wireless device, comprising a processor; memory coupled with the processor; and instructions stored in the memory and executable by the processor to cause the apparatus to perform a method of any of aspects 1 through 15.
Aspect 25: An apparatus for wireless communication at a first wireless device, comprising at least one means for performing a method of any of aspects 1 through 15.
Aspect 26: A non-transitory computer-readable medium storing code for wireless communication at a first wireless device, the code comprising instructions executable by a processor to perform a method of any of aspects 1 through 15.
Aspect 27: An apparatus for wireless communication at a second wireless device, comprising a processor; memory coupled with the processor; and instructions stored in the memory and executable by the processor to cause the apparatus to perform a method of any of aspects 16 through 23.
Aspect 28: An apparatus for wireless communication at a second wireless device, comprising at least one means for performing a method of any of aspects 16 through 23.
Aspect 29: A non-transitory computer-readable medium storing code for wireless communication at a second wireless device, the code comprising instructions executable by a processor to perform a method of any of aspects 16 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a first wireless device, comprising:
communicating control signaling identifying one or more parameters for staircase encoding;
performing, in accordance with the one or more parameters, a staircase encoding procedure on a plurality of information bits to generate a set of encoded bits, the staircase encoding procedure at a current step comprising:
concatenating a first set of shaping bits with a first set of information bits to generate a second set of bits, the first set of shaping bits associated with shaping a first set of bits from a previous step of the staircase encoding procedure, and the first set of information bits for the current step;
performing a channel decoding procedure on the second set of bits to generate a second set of shaping bits to be used in a subsequent step of the staircase encoding procedure;
performing a forward error correction encoding procedure on a third set of bits to generate a set of parity bits, the third set of bits being based at least in part on the second set of bits; and
mapping the third set of bits and the set of parity bits to a set of symbols to generate a fourth set of bits for the subsequent step of the staircase encoding procedure; and
transmitting the set of encoded bits to a second wireless device.

2. The method of claim 1, wherein communicating the control signaling identifying the one or more parameters for staircase encoding comprises:
communicating an indication of a length of each code block of a plurality of code blocks to be used for staircase encoding, wherein the second set of bits is based at least in part on the length.

3. The method of claim 2, further comprising:
determining, based at least in part on the length of each code block, a quantity of component codes to be used for channel decoding, wherein performing the channel decoding procedure is based at least in part on the quantity of component codes.

4. The method of claim 1, wherein communicating the control signaling identifying the one or more parameters for staircase encoding comprises:
communicating an indication of a coding rate to be used for staircase encoding, wherein the second set of shaping bits is based at least in part on the coding rate.

5. The method of claim 4, wherein the second set of shaping bits is further based as least in part on a quantity of bits to be carried by each symbol of the set of symbols.

6. The method of claim 1, wherein communicating the control signaling identifying the one or more parameters for staircase encoding comprises:
communicating an indication of a quantity of component codes to be used for channel decoding, wherein the channel decoding procedure is performed using one or more component codes based at least in part on the quantity of component codes.

7. The method of claim 1, wherein the channel decoding procedure and the forward error correction encoding procedure are performed concurrently at least in part.

8. The method of claim 1, wherein the forward error correction encoding procedure is performed subsequently to the channel decoding procedure.

9. The method of claim 1, wherein performing the staircase encoding procedure further comprises:
performing a channel encoding procedure using the second set of bits to generate the third set of bits, wherein performing the forward error correction encoding procedure is based at least in part on the channel encoding procedure.

10. The method of claim 9, wherein the third set of bits comprises cover code bits.

11. The method of claim 9, further comprising:
performing a bit-masking procedure on a portion of the third set of bits, to obtain a shaped portion of the third set of bits, wherein the forward error correction encoding procedure is further based at least in part on the bit-masking procedure.

12. The method of claim 9, the channel encoding procedure is performed using a polar encoder.

13. The method of claim 1, wherein the first wireless device comprises a user equipment (UE) and communicating the control signaling identifying the one or more parameters for staircase encoding comprises:
receiving the control signaling identifying the one or more parameters for staircase encoding, wherein performing the staircase encoding procedure is based at least in part on receiving the control signaling.

14. The method of claim 1, wherein the first wireless device comprises a network entity and communicating the control signaling identifying the one or more parameters for staircase encoding comprises:
transmitting the control signaling identifying the one or more parameters for staircase encoding, wherein performing the staircase encoding procedure is based at least in part on transmitting the control signaling.

15. The method of claim 1, wherein the channel decoding procedure is performed using a polar decoder.

16. A method for wireless communication at a second wireless device, comprising:
communicating control signaling identifying one or more parameters for staircase decoding;
receiving a set of symbols from a first wireless device;
performing, in accordance with the one or more parameters, a staircase decoding procedure on the set of symbols to generate a set of information bits, the staircase decoding procedure at a current step comprising:
mapping the set of symbols to a first set of bits for the current step of the staircase decoding procedure;
performing a forward error correction decoding procedure on the first set of bits to generate a set of shaping bits and a second set of bits to be used in the current step of the staircase decoding procedure; and
performing a bit-masking procedure on the second set of bits to generate a third set bits to be used in a subsequent step of the staircase decoding procedure, the bit-masking procedure based at least in part on the set of shaping bits; and
outputting the set of information bits.

17. The method of claim 16, wherein communicating the control signaling identifying the one or more parameters for staircase encoding comprises:
communicating an indication of a length of each code block of a plurality of code blocks to be used for staircase decoding, wherein the second set of bits is based at least in part on the length.

18. The method of claim 16, wherein communicating the control signaling identifying the one or more parameters for staircase decoding comprises:
communicating an indication of a coding rate to be used for staircase decoding, wherein the set of shaping bits is based at least in part on the coding rate.

19. The method of claim 18, wherein the set of shaping bits is further based as least in part on a quantity of bits carried by each symbol of the set of symbols.

20. The method of claim 16, wherein communicating the control signaling identifying the one or more parameters for staircase decoding comprises:
communicating an indication of a quantity of component codes to be used for staircase decoding, wherein the staircase decoding procedure is based at least in part on the quantity of component codes.

21. The method of claim 16, wherein performing the staircase decoding procedure further comprises:
performing a channel encoding procedure on the set of shaping bits, wherein the bit-masking procedure is based at least in part on performing the channel encoding procedure.

22. The method of claim 16, wherein the second wireless device comprises a user equipment (UE) and communicating the control signaling identifying the one or more parameters for staircase encoding comprises:
receiving the control signaling identifying the one or more parameters for staircase decoding, wherein performing the staircase decoding procedure is based at least in part on receiving the control signaling.

23. The method of claim 16, wherein the second wireless device comprises a network entity and communicating the control signaling identifying the one or more parameters for staircase decoding comprises:
transmitting the control signaling identifying the one or more parameters for staircase decoding, wherein performing the staircase decoding procedure is based at least in part on transmitting the control signaling.

24. An apparatus for wireless communication at a first wireless device, comprising:
a processor;
memory coupled with the processor; and
instructions stored in the memory and executable by the processor to cause the apparatus to:
communicate control signaling identifying one or more parameters for staircase encoding;
perform, in accordance with the one or more parameters, a staircase encoding procedure on a plurality of information bits to generate a set of encoded bits, the staircase encoding procedure at a current step comprising:
concatenate a first set of shaping bits with a first set of information bits to generate a second set of bits, the first set of shaping bits associated with shaping a first set of bits from a previous step of the staircase encoding procedure, and the first set of information bits for the current step;
perform a channel decoding procedure on the second set of bits to generate a second set of shaping bits to be used in a subsequent step of the staircase encoding procedure;
perform a forward error correction encoding procedure on a third set of bits to generate a set of parity bits, the third set of bits being based at least in part on the second set of bits; and
map the third set of bits and the set of parity bits to a set of symbols to generate a fourth set of bits for the subsequent step of the staircase encoding procedure; and
transmit the set of encoded bits to a second wireless device.

25. The apparatus of claim 24, wherein the instructions to communicate the control signaling identifying the one or more parameters for staircase encoding are executable by the processor to cause the apparatus to:
communicate an indication of a length of each code block of a plurality of code blocks to be used for staircase encoding, wherein the second set of bits is based at least in part on the length.

26. The apparatus of claim 24, wherein the instructions to communicate the control signaling identifying the one or more parameters for staircase encoding are executable by the processor to cause the apparatus to:
communicate an indication of a coding rate to be used for staircase encoding, wherein the second set of shaping bits is based at least in part on the coding rate.

27. An apparatus for wireless communication at a second wireless device, comprising:
a processor;
memory coupled with the processor; and
instructions stored in the memory and executable by the processor to cause the apparatus to:
communicate control signaling identifying one or more parameters for staircase decoding;
receive a set of symbols from a first wireless device;
perform, in accordance with the one or more parameters, a staircase decoding procedure on the set of symbols to generate a set of information bits, the staircase decoding procedure at a current step comprising:
map the set of symbols to a first set of bits for the current step of the staircase decoding procedure;
perform a forward error correction decoding procedure on the first set of bits to generate a set of shaping bits and a second set of bits to be used in the current step of the staircase decoding procedure; and
perform a bit-masking procedure on the second set of bits to generate a third set bits to be used in a subsequent step of the staircase decoding procedure, the bit-masking procedure based at least in part on the set of shaping bits; and
output the set of information bits.

28. The apparatus of claim 27, wherein the instructions to communicate the control signaling identifying the one or more parameters for staircase encoding are executable by the processor to cause the apparatus to:
communicate an indication of a length of each code block of a plurality of code blocks to be used for staircase decoding, wherein the second set of bits is based at least in part on the length.

29. The apparatus of claim 27, wherein the instructions to communicate the control signaling identifying the one or more parameters for staircase decoding are executable by the processor to cause the apparatus to:
communicate an indication of a coding rate to be used for staircase decoding, wherein the set of shaping bits is based at least in part on the coding rate.

30. The apparatus of claim 27, wherein the instructions to communicate the control signaling identifying the one or more parameters for staircase decoding are executable by the processor to cause the apparatus to:
communicate an indication of a quantity of component codes to be used for staircase decoding, wherein the staircase decoding procedure is based at least in part on the quantity of component codes.
